(19) United States
(12) Patent Application Publication
(10) Pub. No.: US 2025/0184905 A1
(43) Pub. Date: Jun. 5, 2025

(54) OPEN LOOP POWER CONTROL PARAMETER SET FOR FULL-DUPLEX NETWORKS

(71) Applicant: QUALCOMM Incorporated, San Diego, CA (US)

(72) Inventors: Ahmed Attia ABOTABL, San Diego, CA (US); Abdelrahman Mohamed Ahmed Mohamed IBRAHIM, San Diego, CA (US); Muhammad Sayed Khairy ABDELGHAFFAR, San Jose, CA (US)

(21) Appl. No.: 18/525,705

(22) Filed: Nov. 30, 2023

(51) Int. Cl. H04W 52/10; H04L 5/14; H04W 72/231

(52) U.S. Cl. CPC H04W 52/10; H04L 5/14; H04W 72/231

(57) ABSTRACT

The apparatus may be a UE configured to receive a configuration of two or more open loop power values in one or more open loop power control parameter sets, each open loop power value of the two or more open loop power values associated with a different duplex mode. The apparatus may also be configured to receive an indication of an open loop power value of the two or more open loop power values in the one or more open loop power control parameter sets and transmit an uplink transmission with a transmission power based on the open loop power value in the one or more open loop power control parameter sets.

### TECHNICAL FIELD

The present disclosure relates generally to communication systems, and more particularly, to power control for wireless communication.

### INTRODUCTION

Wireless communication systems are widely deployed to provide various telecommunication services such as telephony, video, data, messaging, and broadcasts. Typical wireless communication systems may employ multiple-access technologies capable of supporting communication with multiple users by sharing available system resources. Examples of such multiple-access technologies include code division multiple access (CDMA) systems, time division multiple access (TDMA) systems, frequency division multiple access (FDMA) systems, orthogonal frequency division multiple access (OFDMA) systems, single-carrier frequency division multiple access (SC-FDMA) systems, and time division synchronous code division multiple access (TD-SCDMA) systems.

These multiple access technologies have been adopted in various telecommunication standards to provide a common protocol that enables different wireless devices to communicate on a municipal, national, regional, and even global level. An example telecommunication standard is 5G New Radio (NR). 5G NR is part of a continuous mobile broadband evolution promulgated by Third Generation Partnership Project (3GPP) to meet new requirements associated with latency, reliability, security, scalability (e.g., with Internet of Things (IoT)), and other requirements. 5G NR includes services associated with enhanced mobile broadband (eMBB), massive machine type communications (mMTC), and ultra-reliable low latency communications (URLLC). Some aspects of 5G NR may be based on the 4G Long Term Evolution (LTE) standard. There exists a need for further improvements in 5G NR technology. These improvements may also be applicable to other multi-access technologies and the telecommunication standards that employ these technologies.

### BRIEF SUMMARY

The following presents a simplified summary of one or more aspects in order to provide a basic understanding of such aspects. This summary is not an extensive overview of all contemplated aspects. This summary neither identifies key or critical elements of all aspects nor delineates the scope of any or all aspects. Its sole purpose is to present some concepts of one or more aspects in a simplified form as a prelude to the more detailed description that is presented later.

In an aspect of the disclosure, a method, a computer-readable medium, and an apparatus are provided. The apparatus may be a wireless device or component of a wireless device configured to receive a configuration of two or more open loop power values in one or more open loop power control parameter sets, each open loop power value of the two or more open loop power values associated with a different duplex mode. The apparatus may also be configured to receive an indication of an open loop power value of the two or more open loop power values in the one or more open loop power control parameter sets and transmit an uplink transmission with a transmission power based on the open loop power value in the one or more open loop power control parameter sets.

In an aspect of the disclosure, a method, a computer-readable medium, and an apparatus are provided. The apparatus may be a network device or component of a network device configured to output a configuration of two or more open loop power values in one or more open loop power control parameter sets, each open loop power value of the two or more open loop power values associated with a different duplex mode. The apparatus may also be configured to transmit an indication of an open loop power value of the two or more open loop power values in the one or more open loop power control parameter sets and receive an uplink transmission with a transmission power based on the open loop power value in the one or more open loop power control parameter sets.

To the accomplishment of the foregoing and related ends, the one or more aspects may include the features hereinafter fully described and particularly pointed out in the claims. The following description and the drawings set forth in detail certain illustrative features of the one or more aspects. These features are indicative, however, of but a few of the various ways in which the principles of various aspects may be employed.

### BRIEF DESCRIPTION OF THE DRAWINGS

FIG. 1 is a diagram illustrating an example of a wireless communications system and an access network.

FIG. 2A is a diagram illustrating an example of a first frame, in accordance with various aspects of the present disclosure.

FIG. 2B is a diagram illustrating an example of downlink (DL) channels within a subframe, in accordance with various aspects of the present disclosure.

FIG. 2C is a diagram illustrating an example of a second frame, in accordance with various aspects of the present disclosure.

FIG. 2D is a diagram illustrating an example of uplink (UL) channels within a subframe, in accordance with various aspects of the present disclosure.

FIG. 3 is a diagram illustrating an example of a base station and user equipment (UE) in an access network.

FIG. 4 is a diagram illustrating a set of power control parameter set lists, sets, and values that may be configured for a UE.

FIG. 5 is a call flow diagram of a method for open loop power control parameter indication in accordance with some aspects of the disclosure.

FIG. 6 is a diagram illustrating possible configurations of open loop power control parameter sets in accordance with some aspects of the disclosure.

FIG. 7 is a diagram illustrating a possible configuration of open loop power control parameter sets and corresponding indications of particular open loop power values in accordance with some aspects of the disclosure.

FIG. 8 is a flowchart of a method of wireless communication.

FIG. 9 is a flowchart of a method of wireless communication.

FIG. 10 is a flowchart of a method of wireless communication.

FIG. 11 is a diagram illustrating an example of a hardware implementation for an example apparatus and/or network entity.

FIG. 12 is a diagram illustrating an example of a hardware implementation for an example network entity.

### DETAILED DESCRIPTION

In some aspects, of wireless communication, open loop power control may be used for boosting and/or reducing power in response to changing conditions. Depending on changing conditions and/or on a slot type, an open loop power control parameter set may be used differently. For example, a base station may determine that a transmission power of an uplink communication from a wireless device (e.g., a physical uplink shared channel (PUSCH) communication) is too low to overcome the self-interference at the base station and request and/or indicate for the wireless device (or UE) to increase a transmission power. Alternatively, or additionally, a base station may determine that a transmission power is too high (e.g., is causing cross-link interference (CLI)) and may request and/or indicate for the wireless device (or UE) to reduce the transmission power to reduce the CLI at other UEs receiving downlink (DL) transmissions. In some aspects, an open loop power control parameter may be used to control this behavior across different slot types.

In some aspects, an open loop power control parameter set that may be appropriate for transmissions associated with a first mode of operation (e.g., a full-duplex mode of operation) may not be appropriate for a second mode of operation (e.g., a half-duplex mode of operation). For example, a full duplex mode may be associated with a higher power transmission (and a first associated open loop power control parameter or parameter set) from a wireless device to overcome self-interference at a base station while a half-duplex mode of operation may be associated with a lower power transmission (and a second associated open loop power control parameter or parameter set) to avoid generating, or minimizing, CLI. However, for changes back and forth between a full-duplex mode of operation and a half-duplex mode of operation (or between communication based on full-duplex resources and half-duplex resources), the use of a single open loop control parameter (or parameter set) may lead to sub-optimal transmission power for at least one of the two duplex modes. For example, even if an open loop power control parameter set includes more than one power (e.g., if a PUSCH-Set is configured with more than one P0 value) a rule for the use of these other values may not accommodate the switch between the modes of operation (e.g., full-duplex and/or half-duplex).

Various aspects relate generally to enabling the network to signal open loop power control parameters (e.g., values for P0) differently, e.g., based on a mode of operation such as a duplex mode (e.g., full-duplex, or half-duplex). Some aspects more specifically relate to configuring two or more open loop power control parameters (or open loop power values) associated with different modes of operation. In some examples, a wireless device may be configured to receive a configuration of two or more open loop power values in one or more open loop power control parameter sets, each open loop power value of the two or more open loop power values associated with a different duplex mode. The wireless device may also be configured to receive an indication of an open loop power value of the two or more open loop power values in the one or more open loop power control parameter sets and transmit an uplink transmission with a transmission power based on the open loop power value in the one or more open loop power control parameter sets.

Particular aspects of the subject matter described in this disclosure can be implemented to realize one or more of the following potential advantages. In some examples, by configuring two or more open loop power control parameters (or open loop power values) associated with different modes of operation, the described techniques can be used to a transmission power dynamically for different modes of operation and/or using a larger number of candidate transmission powers (e.g., open loop power values or power control parameters) to more accurately match a desired power.

The detailed description set forth below in connection with the drawings describes various configurations and does not represent the only configurations in which the concepts described herein may be practiced. The detailed description includes specific details for the purpose of providing a thorough understanding of various concepts. However, these concepts may be practiced without these specific details. In some instances, well known structures and components are shown in block diagram form in order to avoid obscuring such concepts.

Several aspects of telecommunication systems are presented with reference to various apparatus and methods. These apparatus and methods are described in the following detailed description and illustrated in the accompanying drawings by various blocks, components, circuits, processes, algorithms, etc. (collectively referred to as “elements”). These elements may be implemented using electronic hardware, computer software, or any combination thereof. Whether such elements are implemented as hardware or software depends upon the particular application and design constraints imposed on the overall system.

By way of example, an element, or any portion of an element, or any combination of elements may be implemented as a “processing system” that includes one or more processors. When multiple processors are implemented, the multiple processors may perform the functions individually or in combination. Examples of processors include microprocessors, microcontrollers, graphics processing units (GPUs), central processing units (CPUs), application processors, digital signal processors (DSPs), reduced instruction set computing (RISC) processors, systems on a chip (SoC), baseband processors, field programmable gate arrays (FPGAs), programmable logic devices (PLDs), state machines, gated logic, discrete hardware circuits, and other suitable hardware configured to perform the various functionality described throughout this disclosure. One or more processors in the processing system may execute software. Software, whether referred to as software, firmware, middleware, microcode, hardware description language, or otherwise, shall be construed broadly to mean instructions, instruction sets, code, code segments, program code, programs, subprograms, software components, applications, software applications, software packages, routines, subroutines, objects, executables, threads of execution, procedures, functions, or any combination thereof.

Accordingly, in one or more example aspects, implementations, and/or use cases, the functions described may be implemented in hardware, software, or any combination thereof. If implemented in software, the functions may be stored on or encoded as one or more instructions or code on a computer-readable medium. Computer-readable media includes computer storage media. Storage media may be any available media that can be accessed by a computer. By way of example, such computer-readable media can include a random-access memory (RAM), a read-only memory (ROM), an electrically erasable programmable ROM (EEPROM), optical disk storage, magnetic disk storage, other magnetic storage devices, combinations of the types of computer-readable media, or any other medium that can be used to store computer executable code in the form of instructions or data structures that can be accessed by a computer.

While aspects, implementations, and/or use cases are described in this application by illustration to some examples, additional or different aspects, implementations and/or use cases may come about in many different arrangements and scenarios. Aspects, implementations, and/or use cases described herein may be implemented across many differing platform types, devices, systems, shapes, sizes, and packaging arrangements. For example, aspects, implementations, and/or use cases may come about via integrated chip implementations and other non-module-component based devices (e.g., end-user devices, vehicles, communication devices, computing devices, industrial equipment, retail/purchasing devices, medical devices, artificial intelligence (AI)-enabled devices, etc.). While some examples may or may not be specifically directed to use cases or applications, a wide assortment of applicability of described examples may occur. Aspects, implementations, and/or use cases may range a spectrum from chip-level or modular components to non-modular, non-chip-level implementations and further to aggregate, distributed, or original equipment manufacturer (OEM) devices or systems incorporating one or more techniques herein. In some practical settings, devices incorporating described aspects and features may also include additional components and features for implementation and practice of claimed and described aspect. For example, transmission and reception of wireless signals necessarily includes a number of components for analog and digital purposes (e.g., hardware components including antenna, RF-chains, power amplifiers, modulators, buffer, processor(s), interleaver, adders/summers, etc.). Techniques described herein may be practiced in a wide variety of devices, chip-level components, systems, distributed arrangements, aggregated or disaggregated components, end-user devices, etc. of varying sizes, shapes, and constitution.

Deployment of communication systems, such as 5G NR systems, may be arranged in multiple manners with various components or constituent parts. In a 5G NR system, or network, a network node, a network entity, a mobility element of a network, a radio access network (RAN) node, a core network node, a network element, or a network equipment, such as a base station (BS), or one or more units (or one or more components) performing base station functionality, may be implemented in an aggregated or disaggregated architecture. For example, a BS (such as a Node B (NB), evolved NB (eNB), NR BS, 5G NB, access point (AP), a transmission reception point (TRP), or a cell, etc.) may be implemented as an aggregated base station (also known as a standalone BS or a monolithic BS) or a disaggregated base station.

An aggregated base station may be configured to utilize a radio protocol stack that is physically or logically integrated within a single RAN node. A disaggregated base station may be configured to utilize a protocol stack that is physically or logically distributed among two or more units (such as one or more central or centralized units (CUs), one or more distributed units (DUs), or one or more radio units (RUs)). In some aspects, a CU may be implemented within a RAN node, and one or more DUs may be co-located with the CU, or alternatively, may be geographically or virtually distributed throughout one or multiple other RAN nodes. The DUs may be implemented to communicate with one or more RUs. Each of the CU, DU and RU can be implemented as virtual units, i.e., a virtual central unit (VCU), a virtual distributed unit (VDU), or a virtual radio unit (VRU).

Base station operation or network design may consider aggregation characteristics of base station functionality. For example, disaggregated base stations may be utilized in an integrated access backhaul (IAB) network, an open radio access network (O-RAN (such as the network configuration sponsored by the O-RAN Alliance)), or a virtualized radio access network (vRAN, also known as a cloud radio access network (C-RAN)). Disaggregation may include distributing functionality across two or more units at various physical locations, as well as distributing functionality for at least one unit virtually, which can enable flexibility in network design. The various units of the disaggregated base station, or disaggregated RAN architecture, can be configured for wired or wireless communication with at least one other unit.

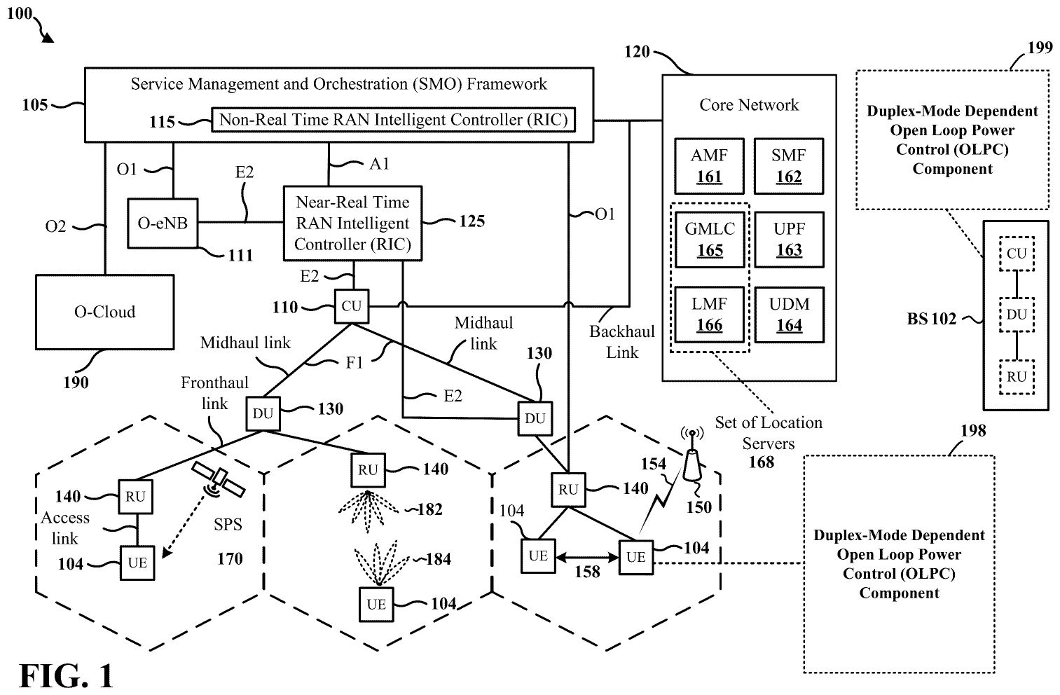

FIG. 1 is a diagram 100 illustrating an example of a wireless communications system and an access network. The illustrated wireless communications system includes a disaggregated base station architecture. The disaggregated base station architecture may include one or more CUs 110 that can communicate directly with a core network 120 via a backhaul link, or indirectly with the core network 120 through one or more disaggregated base station units (such as a Near-Real Time (Near-RT) RAN Intelligent Controller (RIC) 125 via an E2 link, or a Non-Real Time (Non-RT) RIC 115 associated with a Service Management and Orchestration (SMO) Framework 105, or both). A CU 110 may communicate with one or more DUs 130 via respective midhaul links, such as an F1 interface. The DUs 130 may communicate with one or more RUs 140 via respective fronthaul links. The RUs 140 may communicate with respective UEs 104 via one or more radio frequency (RF) access links. In some implementations, the UE 104 may be simultaneously served by multiple RUs 140.

Each of the units, i.e., the CUS 110, the DUs 130, the RUs 140, as well as the Near-RT RICs 125, the Non-RT RICs 115, and the SMO Framework 105, may include one or more interfaces or be coupled to one or more interfaces configured to receive or to transmit signals, data, or information (collectively, signals) via a wired or wireless transmission medium. Each of the units, or an associated processor or controller providing instructions to the communication interfaces of the units, can be configured to communicate with one or more of the other units via the transmission medium. For example, the units can include a wired interface configured to receive or to transmit signals over a wired transmission medium to one or more of the other units. Additionally, the units can include a wireless interface, which may include a receiver, a transmitter, or a transceiver (such as an RF transceiver), configured to receive or to transmit signals, or both, over a wireless transmission medium to one or more of the other units.

In some aspects, the CU 110 may host one or more higher layer control functions. Such control functions can include radio resource control (RRC), packet data convergence protocol (PDCP), service data adaptation protocol (SDAP), or the like. Each control function can be implemented with an interface configured to communicate signals with other control functions hosted by the CU 110. The CU 110 may be configured to handle user plane functionality (i.e., Central Unit-User Plane (CU-UP)), control plane functionality (i.e., Central Unit-Control Plane (CU-CP)), or a combination thereof. In some implementations, the CU 110 can be logically split into one or more CU-UP units and one or more CU-CP units. The CU-UP unit can communicate bidirectionally with the CU-CP unit via an interface, such as an E1 interface when implemented in an O-RAN configuration. The CU 110 can be implemented to communicate with the DU 130, as necessary, for network control and signaling.

The DU 130 may correspond to a logical unit that includes one or more base station functions to control the operation of one or more RUs 140. In some aspects, the DU 130 may host one or more of a radio link control (RLC) layer, a medium access control (MAC) layer, and one or more high physical (PHY) layers (such as modules for forward error correction (FEC) encoding and decoding, scrambling, modulation, demodulation, or the like) depending, at least in part, on a functional split, such as those defined by 3GPP. In some aspects, the DU 130 may further host one or more low PHY layers. Each layer (or module) can be implemented with an interface configured to communicate signals with other layers (and modules) hosted by the DU 130, or with the control functions hosted by the CU 110.

Lower-layer functionality can be implemented by one or more RUs 140. In some deployments, an RU 140, controlled by a DU 130, may correspond to a logical node that hosts RF processing functions, or low-PHY layer functions (such as performing fast Fourier transform (FFT), inverse FFT (iFFT), digital beamforming, physical random access channel (PRACH) extraction and filtering, or the like), or both, based at least in part on the functional split, such as a lower layer functional split. In such an architecture, the RU(s) 140 can be implemented to handle over the air (OTA) communication with one or more UEs 104. In some implementations, real-time and non-real-time aspects of control and user plane communication with the RU(s) 140 can be controlled by the corresponding DU 130. In some scenarios, this configuration can enable the DU(s) 130 and the CU 110 to be implemented in a cloud-based RAN architecture, such as a vRAN architecture.

The SMO Framework 105 may be configured to support RAN deployment and provisioning of non-virtualized and virtualized network elements. For non-virtualized network elements, the SMO Framework 105 may be configured to support the deployment of dedicated physical resources for RAN coverage requirements that may be managed via an operations and maintenance interface (such as an O1 interface). For virtualized network elements, the SMO Framework 105 may be configured to interact with a cloud computing platform (such as an open cloud (O-Cloud) 190) to perform network element life cycle management (such as to instantiate virtualized network elements) via a cloud computing platform interface (such as an O2 interface). Such virtualized network elements can include, but are not limited to, CUs 110, DUs 130, RUs 140 and Near-RT RICs 125. In some implementations, the SMO Framework 105 can communicate with a hardware aspect of a 4G RAN, such as an open eNB (O-eNB) 111, via an O1 interface. Additionally, in some implementations, the SMO Framework 105 can communicate directly with one or more RUs 140 via an O1 interface. The SMO Framework 105 also may include a Non-RT RIC 115 configured to support functionality of the SMO Framework 105.

The Non-RT RIC 115 may be configured to include a logical function that enables non-real-time control and optimization of RAN elements and resources, artificial intelligence (AI)/machine learning (ML) (AI/ML) workflows including model training and updates, or policy-based guidance of applications/features in the Near-RT RIC 125. The Non-RT RIC 115 may be coupled to or communicate with (such as via an A1 interface) the Near-RT RIC 125. The Near-RT RIC 125 may be configured to include a logical function that enables near-real-time control and optimization of RAN elements and resources via data collection and actions over an interface (such as via an E2 interface) connecting one or more CUs 110, one or more DUs 130, or both, as well as an O-eNB, with the Near-RT RIC 125.

In some implementations, to generate AI/ML models to be deployed in the Near-RT RIC 125, the Non-RT RIC 115 may receive parameters or external enrichment information from external servers. Such information may be utilized by the Near-RT RIC 125 and may be received at the SMO Framework 105 or the Non-RT RIC 115 from non-network data sources or from network functions. In some examples, the Non-RT RIC 115 or the Near-RT RIC 125 may be configured to tune RAN behavior or performance. For example, the Non-RT RIC 115 may monitor long-term trends and patterns for performance and employ AI/ML models to perform corrective actions through the SMO Framework 105 (such as reconfiguration via 01) or via creation of RAN management policies (such as A1 policies).

At least one of the CU 110, the DU 130, and the RU 140 may be referred to as a base station 102. Accordingly, a base station 102 may include one or more of the CU 110, the DU 130, and the RU 140 (each component indicated with dotted lines to signify that each component may or may not be included in the base station 102). The base station 102 provides an access point to the core network 120 for a UE 104. The base station 102 may include macrocells (high power cellular base station) and/or small cells (low power cellular base station). The small cells include femtocells, picocells, and microcells. A network that includes both small cell and macrocells may be known as a heterogeneous network. A heterogeneous network may also include Home Evolved Node Bs (eNBs) (HeNBs), which may provide service to a restricted group known as a closed subscriber group (CSG). The communication links between the RUs 140 and the UEs 104 may include uplink (UL) (also referred to as reverse link) transmissions from a UE 104 to an RU 140 and/or downlink (DL) (also referred to as forward link) transmissions from an RU 140 to a UE 104. The communication links may use multiple-input and multiple-output (MIMO) antenna technology, including spatial multiplexing, beamforming, and/or transmit diversity. The communication links may be through one or more carriers. The base station 102/UEs 104 may use spectrum up to Y MHz (e.g., 5, 10, 15, 20, 100, 400, etc. MHz) bandwidth per carrier allocated in a carrier aggregation of up to a total of Yx MHz (x component carriers) used for transmission in each direction. The carriers may or may not be adjacent to each other. Allocation of carriers may be asymmetric with respect to DL and UL (e.g., more or fewer carriers may be allocated for DL than for UL). The component carriers may include a primary component carrier and one or more secondary component carriers. A primary component carrier may be referred to as a primary cell (PCell) and a secondary component carrier may be referred to as a secondary cell (SCell).

Certain UEs 104 may communicate with each other using device-to-device (D2D) communication link 158. The D2D communication link 158 may use the DL/UL wireless wide area network (WWAN) spectrum. The D2D communication link 158 may use one or more sidelink channels, such as a physical sidelink broadcast channel (PSBCH), a physical sidelink discovery channel (PSDCH), a physical sidelink shared channel (PSSCH), and a physical sidelink control channel (PSCCH). D2D communication may be through a variety of wireless D2D communications systems, such as for example, Bluetooth™ (Bluetooth is a trademark of the Bluetooth Special Interest Group (SIG)), Wi-Fi™ (Wi-Fi is a trademark of the Wi-Fi Alliance) based on the Institute of Electrical and Electronics Engineers (IEEE) 802.11 standard, LTE, or NR.

The wireless communications system may further include a Wi-Fi AP 150 in communication with UEs 104 (also referred to as Wi-Fi stations (STAs)) via communication link 154, e.g., in a 5 GHz unlicensed frequency spectrum or the like. When communicating in an unlicensed frequency spectrum, the UEs 104/AP 150 may perform a clear channel assessment (CCA) prior to communicating in order to determine whether the channel is available.

The electromagnetic spectrum is often subdivided, based on frequency/wavelength, into various classes, bands, channels, etc. In 5G NR, two initial operating bands have been identified as frequency range designations FR1 (410 MHz-7.125 GHZ) and FR2 (24.25 GHz-52.6 GHZ). Although a portion of FR1 is greater than 6 GHz, FR1 is often referred to (interchangeably) as a “sub-6 GHz” band in various documents and articles. A similar nomenclature issue sometimes occurs with regard to FR2, which is often referred to (interchangeably) as a “millimeter wave” band in documents and articles, despite being different from the extremely high frequency (EHF) band (30 GHz-300 GHz) which is identified by the International Telecommunications Union (ITU) as a “millimeter wave” band.

The frequencies between FR1 and FR2 are often referred to as mid-band frequencies. Recent 5G NR studies have identified an operating band for these mid-band frequencies as frequency range designation FR3 (7.125 GHz-24.25 GHZ). Frequency bands falling within FR3 may inherit FR1 characteristics and/or FR2 characteristics, and thus may effectively extend features of FR1 and/or FR2 into mid-band frequencies. In addition, higher frequency bands are currently being explored to extend 5G NR operation beyond 52.6 GHz. For example, three higher operating bands have been identified as frequency range designations FR2-2 (52.6 GHz-71 GHz), FR4 (71 GHz-114.25 GHz), and FR5 (114.25 GHZ-300 GHz). Each of these higher frequency bands falls within the EHF band.

With the above aspects in mind, unless specifically stated otherwise, the term “sub-6 GHz” or the like if used herein may broadly represent frequencies that may be less than 6 GHZ, may be within FR1, or may include mid-band frequencies. Further, unless specifically stated otherwise, the term “millimeter wave” or the like if used herein may broadly represent frequencies that may include mid-band frequencies, may be within FR2, FR4, FR2-2, and/or FR5, or may be within the EHF band.

The base station 102 and the UE 104 may each include a plurality of antennas, such as antenna elements, antenna panels, and/or antenna arrays to facilitate beamforming. The base station 102 may transmit a beamformed signal 182 to the UE 104 in one or more transmit directions. The UE 104 may receive the beamformed signal from the base station 102 in one or more receive directions. The UE 104 may also transmit a beamformed signal 184 to the base station 102 in one or more transmit directions. The base station 102 may receive the beamformed signal from the UE 104 in one or more receive directions. The base station 102/UE 104 may perform beam training to determine the best receive and transmit directions for each of the base station 102/UE 104. The transmit and receive directions for the base station 102 may or may not be the same. The transmit and receive directions for the UE 104 may or may not be the same.

The base station 102 may include and/or be referred to as a gNB, Node B, eNB, an access point, a base transceiver station, a radio base station, a radio transceiver, a transceiver function, a basic service set (BSS), an extended service set (ESS), a TRP, network node, network entity, network equipment, or some other suitable terminology. The base station 102 can be implemented as an integrated access and backhaul (IAB) node, a relay node, a sidelink node, an aggregated (monolithic) base station with a baseband unit (BBU) (including a CU and a DU) and an RU, or as a disaggregated base station including one or more of a CU, a DU, and/or an RU. The set of base stations, which may include disaggregated base stations and/or aggregated base stations, may be referred to as next generation (NG) RAN (NG-RAN).

The core network 120 may include an Access and Mobility Management Function (AMF) 161, a Session Management Function (SMF) 162, a User Plane Function (UPF) 163, a Unified Data Management (UDM) 164, one or more location servers 168, and other functional entities. The AMF 161 is the control node that processes the signaling between the UEs 104 and the core network 120. The AMF 161 supports registration management, connection management, mobility management, and other functions. The SMF 162 supports session management and other functions. The UPF 163 supports packet routing, packet forwarding, and other functions. The UDM 164 supports the generation of authentication and key agreement (AKA) credentials, user identification handling, access authorization, and subscription management. The one or more location servers 168 are illustrated as including a Gateway Mobile Location Center (GMLC) 165 and a Location Management Function (LMF) 166. However, generally, the one or more location servers 168 may include one or more location/positioning servers, which may include one or more of the GMLC 165, the LMF 166, a position determination entity (PDE), a serving mobile location center (SMLC), a mobile positioning center (MPC), or the like. The GMLC 165 and the LMF 166 support UE location services. The GMLC 165 provides an interface for clients/applications (e.g., emergency services) for accessing UE positioning information. The LMF 166 receives measurements and assistance information from the NG-RAN and the UE 104 via the AMF 161 to compute the position of the UE 104. The NG-RAN may utilize one or more positioning methods in order to determine the position of the UE 104. Positioning the UE 104 may involve signal measurements, a position estimate, and an optional velocity computation based on the measurements. The signal measurements may be made by the UE 104 and/or the base station 102 serving the UE 104. The signals measured may be based on one or more of a satellite positioning system (SPS) 170 (e.g., one or more of a Global Navigation Satellite System (GNSS), global position system (GPS), non-terrestrial network (NTN), or other satellite position/location system), LTE signals, wireless local area network (WLAN) signals, Bluetooth signals, a terrestrial beacon system (TBS), sensor-based information (e.g., barometric pressure sensor, motion sensor), NR enhanced cell ID (NR E-CID) methods, NR signals (e.g., multi-round trip time (Multi-RTT), DL angle-of-departure (DL-AoD), DL time difference of arrival (DL-TDOA), UL time difference of arrival (UL-TDOA), and UL angle-of-arrival (UL-AoA) positioning), and/or other systems/signals/sensors.

Examples of UEs 104 include a cellular phone, a smart phone, a session initiation protocol (SIP) phone, a laptop, a personal digital assistant (PDA), a satellite radio, a global positioning system, a multimedia device, a video device, a digital audio player (e.g., MP3 player), a camera, a game console, a tablet, a smart device, a wearable device, a vehicle, an electric meter, a gas pump, a large or small kitchen appliance, a healthcare device, an implant, a sensor/actuator, a display, or any other similar functioning device. Some of the UEs 104 may be referred to as IoT devices (e.g., parking meter, gas pump, toaster, vehicles, heart monitor, etc.). The UE 104 may also be referred to as a station, a mobile station, a subscriber station, a mobile unit, a subscriber unit, a wireless unit, a remote unit, a mobile device, a wireless device, a wireless communications device, a remote device, a mobile subscriber station, an access terminal, a mobile terminal, a wireless terminal, a remote terminal, a handset, a user agent, a mobile client, a client, or some other suitable terminology. In some scenarios, the term UE may also apply to one or more companion devices such as in a device constellation arrangement. One or more of these devices may collectively access the network and/or individually access the network.

Referring again to FIG. 1, in certain aspects, the UE 104 may have a duplex-mode-dependent OLPC component 198 that may be configured to receive a configuration of two or more open loop power values in one or more open loop power control parameter sets, each open loop power value of the two or more open loop power values associated with a different duplex mode. The duplex-mode-dependent OLPC component 198 may also be configured to receive an indication of an open loop power value of the two or more open loop power values in the one or more open loop power control parameter sets and transmit an uplink transmission with a transmission power based on the open loop power value in the one or more open loop power control parameter sets. In certain aspects, the base station 102 may have a duplex-mode-dependent OLPC component 199 that may be configured to output a configuration of two or more open loop power values in one or more open loop power control parameter sets, each open loop power value of the two or more open loop power values associated with a different duplex mode. The duplex-mode-dependent OLPC component 199 may also be configured to transmit an indication of an open loop power value of the two or more open loop power values in the one or more open loop power control parameter sets and receive an uplink transmission with a transmission power based on the open loop power value in the one or more open loop power control parameter sets. Although the following description may be focused on 5G NR, the concepts described herein may be applicable to other similar areas, such as LTE, LTE-A, CDMA, GSM, and other wireless technologies.

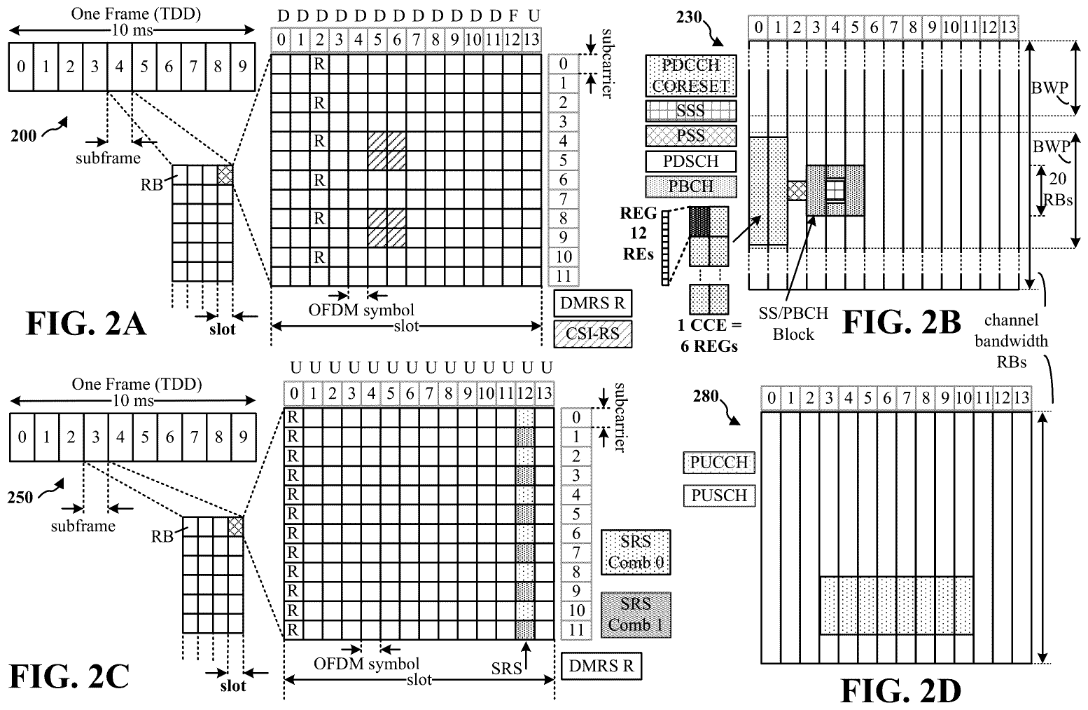

FIG. 2A is a diagram 200 illustrating an example of a first subframe within a 5G NR frame structure. FIG. 2B is a diagram 230 illustrating an example of DL channels within a 5G NR subframe. FIG. 2C is a diagram 250 illustrating an example of a second subframe within a 5G NR frame structure. FIG. 2D is a diagram 280 illustrating an example of UL channels within a 5G NR subframe. The 5G NR frame structure may be frequency division duplexed (FDD) in which for a particular set of subcarriers (carrier system bandwidth), subframes within the set of subcarriers are dedicated for either DL or UL, or may be time division duplexed (TDD) in which for a particular set of subcarriers (carrier system bandwidth), subframes within the set of subcarriers are dedicated for both DL and UL. In the examples provided by FIGS. 2A, 2C, the 5G NR frame structure is assumed to be TDD, with subframe 4 being configured with slot format 28 (with mostly DL), where D is DL, U is UL, and F is flexible for use between DL/UL, and subframe 3 being configured with slot format 1 (with all UL). While subframes 3, 4 are shown with slot formats 1, 28, respectively, any particular subframe may be configured with any of the various available slot formats 0-61. Slot formats 0, 1 are all DL, UL, respectively. Other slot formats 2-61 include a mix of DL, UL, and flexible symbols. UEs are configured with the slot format (dynamically through DL control information (DCI), or semi-statically/statically through radio resource control (RRC) signaling) through a received slot format indicator (SFI). Note that the description infra applies also to a 5G NR frame structure that is TDD.

FIGS. 2A-2D illustrate a frame structure, and the aspects of the present disclosure may be applicable to other wireless communication technologies, which may have a different frame structure and/or different channels. A frame (10 ms) may be divided into 10 equally sized subframes (1 ms). Each subframe may include one or more time slots. Subframes may also include mini-slots, which may include 7, 4, or 2 symbols. Each slot may include 14 or 12 symbols, depending on whether the cyclic prefix (CP) is normal or extended. For normal CP, each slot may include 14 symbols, and for extended CP, each slot may include 12 symbols. The symbols on DL may be CP orthogonal frequency division multiplexing (OFDM) (CP-OFDM) symbols. The symbols on UL may be CP-OFDM symbols (for high throughput scenarios) or discrete Fourier transform (DFT) spread OFDM (DFT-s-OFDM) symbols (for power limited scenarios; limited to a single stream transmission). The number of slots within a subframe is based on the CP and the numerology. The numerology defines the subcarrier spacing (SCS) (see Table 1). The symbol length/duration may scale with 1/SCS.

TABLE 1
Numerology, SCS, and CP

| | SCS | |
|---|---|---|
| μ | Δf = 2^{μ} · 15[kHz] | Cyclic prefix |
| 0 | 15 | Normal |
| 1 | 30 | Normal |
| 2 | 60 | Normal, |
| | | Extended |
| 3 | 120 | Normal |
| 4 | 240 | Normal |
| 5 | 480 | Normal |
| 6 | 960 | Normal |

For normal CP (14 symbols/slot), different numerologies μ 0 to 4 allow for 1, 2, 4, 8, and 16 slots, respectively, per subframe. For extended CP, the numerology 2 allows for 4 slots per subframe. Accordingly, for normal CP and numerology μ, there are 14 symbols/slot and 24 slots/subframe. The subcarrier spacing may be equal to 2^{μ}*15 kHz, where μ is the numerology 0 to 4. As such, the numerology μ=0 has a subcarrier spacing of 15 kHz and the numerology μ=4 has a subcarrier spacing of 240 kHz. The symbol length/duration is inversely related to the subcarrier spacing. FIGS. 2A-2D provide an example of normal CP with 14 symbols per slot and numerology μ=2 with 4 slots per subframe. The slot duration is 0.25 ms, the subcarrier spacing is 60 kHz, and the symbol duration is approximately 16.67 μs. Within a set of frames, there may be one or more different bandwidth parts (BWPs) (see FIG. 2B) that are frequency division multiplexed. Each BWP may have a particular numerology and CP (normal or extended).

A resource grid may be used to represent the frame structure. Each time slot includes a resource block (RB) (also referred to as physical RBs (PRBs)) that extends 12 consecutive subcarriers. The resource grid is divided into multiple resource elements (REs). The number of bits carried by each RE depends on the modulation scheme.

As illustrated in FIG. 2A, some of the REs carry reference (pilot) signals (RS) for the UE. The RS may include demodulation RS (DM-RS) (indicated as R for one particular configuration, but other DM-RS configurations are possible) and channel state information reference signals (CSI-RS) for channel estimation at the UE. The RS may also include beam measurement RS (BRS), beam refinement RS (BRRS), and phase tracking RS (PT-RS).

FIG. 2B illustrates an example of various DL channels within a subframe of a frame. The physical downlink control channel (PDCCH) carries DCI within one or more control channel elements (CCEs) (e.g., 1, 2, 4, 8, or 16 CCEs), each CCE including six RE groups (REGs), each REG including 12 consecutive REs in an OFDM symbol of an RB. A PDCCH within one BWP may be referred to as a control resource set (CORESET). A UE is configured to monitor PDCCH candidates in a PDCCH search space (e.g., common search space, UE-specific search space) during PDCCH monitoring occasions on the CORESET, where the PDCCH candidates have different DCI formats and different aggregation levels. Additional BWPs may be located at greater and/or lower frequencies across the channel bandwidth. A primary synchronization signal (PSS) may be within symbol 2 of particular subframes of a frame. The PSS is used by a UE 104 to determine subframe/symbol timing and a physical layer identity. A secondary synchronization signal (SSS) may be within symbol 4 of particular subframes of a frame. The SSS is used by a UE to determine a physical layer cell identity group number and radio frame timing. Based on the physical layer identity and the physical layer cell identity group number, the UE can determine a physical cell identifier (PCI). Based on the PCI, the UE can determine the locations of the DM-RS. The physical broadcast channel (PBCH), which carries a master information block (MIB), may be logically grouped with the PSS and SSS to form a synchronization signal (SS)/PBCH block (also referred to as SS block (SSB)). The MIB provides a number of RBs in the system bandwidth and a system frame number (SFN). The physical downlink shared channel (PDSCH) carries user data, broadcast system information not transmitted through the PBCH such as system information blocks (SIBs), and paging messages.

As illustrated in FIG. 2C, some of the REs carry DM-RS (indicated as R for one particular configuration, but other DM-RS configurations are possible) for channel estimation at the base station. The UE may transmit DM-RS for the physical uplink control channel (PUCCH) and DM-RS for the physical uplink shared channel (PUSCH). The PUSCH DM-RS may be transmitted in the first one or two symbols of the PUSCH. The PUCCH DM-RS may be transmitted in different configurations depending on whether short or long PUCCHs are transmitted and depending on the particular PUCCH format used. The UE may transmit sounding reference signals (SRS). The SRS may be transmitted in the last symbol of a subframe. The SRS may have a comb structure, and a UE may transmit SRS on one of the combs. The SRS may be used by a base station for channel quality estimation to enable frequency-dependent scheduling on the UL.

FIG. 2D illustrates an example of various UL channels within a subframe of a frame. The PUCCH may be located as indicated in one configuration. The PUCCH carries uplink control information (UCI), such as scheduling requests, a channel quality indicator (CQI), a precoding matrix indicator (PMI), a rank indicator (RI), and hybrid automatic repeat request (HARQ) acknowledgment (ACK) (HARQ-ACK) feedback (i.e., one or more HARQ ACK bits indicating one or more ACK and/or negative ACK (NACK)). The PUSCH carries data, and may additionally be used to carry a buffer status report (BSR), a power headroom report (PHR), and/or UCI.

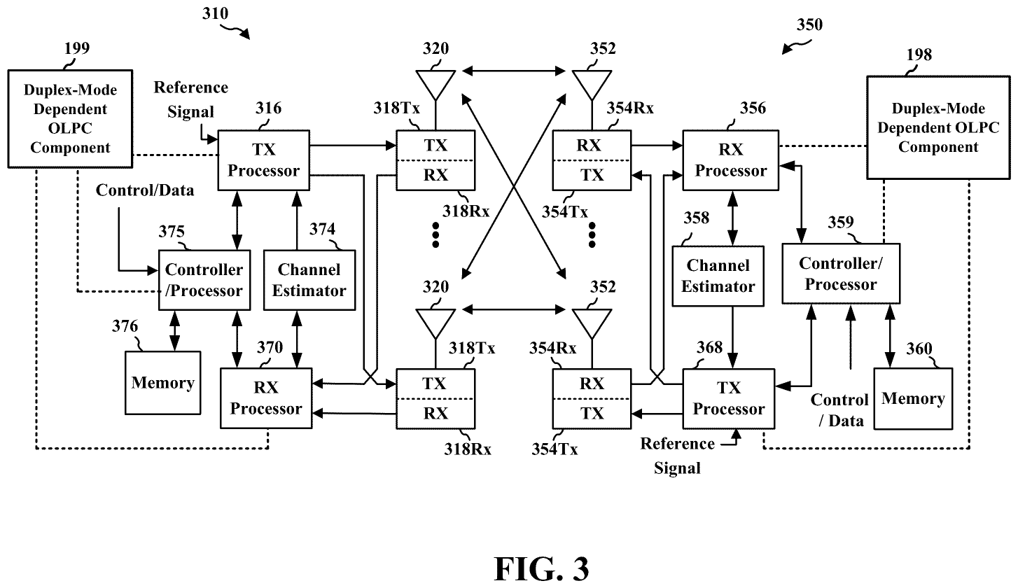

FIG. 3 is a block diagram of a base station 310 in communication with a UE 350 in an access network. In the DL, Internet protocol (IP) packets may be provided to a controller/processor 375. The controller/processor 375 implements layer 3 and layer 2 functionality. Layer 3 includes a radio resource control (RRC) layer, and layer 2 includes a service data adaptation protocol (SDAP) layer, a packet data convergence protocol (PDCP) layer, a radio link control (RLC) layer, and a medium access control (MAC) layer. The controller/processor 375 provides RRC layer functionality associated with broadcasting of system information (e.g., MIB, SIBs), RRC connection control (e.g., RRC connection paging, RRC connection establishment, RRC connection modification, and RRC connection release), inter radio access technology (RAT) mobility, and measurement configuration for UE measurement reporting; PDCP layer functionality associated with header compression/decompression, security (ciphering, deciphering, integrity protection, integrity verification), and handover support functions; RLC layer functionality associated with the transfer of upper layer packet data units (PDUs), error correction through ARQ, concatenation, segmentation, and reassembly of RLC service data units (SDUs), re-segmentation of RLC data PDUs, and reordering of RLC data PDUs; and MAC layer functionality associated with mapping between logical channels and transport channels, multiplexing of MAC SDUs onto transport blocks (TBs), demultiplexing of MAC SDUs from TBs, scheduling information reporting, error correction through HARQ, priority handling, and logical channel prioritization.

The transmit (TX) processor 316 and the receive (RX) processor 370 implement layer 1 functionality associated with various signal processing functions. Layer 1, which includes a physical (PHY) layer, may include error detection on the transport channels, forward error correction (FEC) coding/decoding of the transport channels, interleaving, rate matching, mapping onto physical channels, modulation/demodulation of physical channels, and MIMO antenna processing. The TX processor 316 handles mapping to signal constellations based on various modulation schemes (e.g., binary phase-shift keying (BPSK), quadrature phase-shift keying (QPSK), M-phase-shift keying (M-PSK), M-quadrature amplitude modulation (M-QAM)). The coded and modulated symbols may then be split into parallel streams. Each stream may then be mapped to an OFDM subcarrier, multiplexed with a reference signal (e.g., pilot) in the time and/or frequency domain, and then combined together using an Inverse Fast Fourier Transform (IFFT) to produce a physical channel carrying a time domain OFDM symbol stream. The OFDM stream is spatially precoded to produce multiple spatial streams. Channel estimates from a channel estimator 374 may be used to determine the coding and modulation scheme, as well as for spatial processing. The channel estimate may be derived from a reference signal and/or channel condition feedback transmitted by the UE 350. Each spatial stream may then be provided to a different antenna 320 via a separate transmitter 318Tx. Each transmitter 318Tx may modulate a radio frequency (RF) carrier with a respective spatial stream for transmission.

At the UE 350, each receiver 354Rx receives a signal through its respective antenna 352. Each receiver 354Rx recovers information modulated onto an RF carrier and provides the information to the receive (RX) processor 356. The TX processor 368 and the RX processor 356 implement layer 1 functionality associated with various signal processing functions. The RX processor 356 may perform spatial processing on the information to recover any spatial streams destined for the UE 350. If multiple spatial streams are destined for the UE 350, they may be combined by the RX processor 356 into a single OFDM symbol stream. The RX processor 356 then converts the OFDM symbol stream from the time-domain to the frequency domain using a Fast Fourier Transform (FFT). The frequency domain signal includes a separate OFDM symbol stream for each subcarrier of the OFDM signal. The symbols on each subcarrier, and the reference signal, are recovered and demodulated by determining the most likely signal constellation points transmitted by the base station 310. These soft decisions may be based on channel estimates computed by the channel estimator 358. The soft decisions are then decoded and deinterleaved to recover the data and control signals that were originally transmitted by the base station 310 on the physical channel. The data and control signals are then provided to the controller/processor 359, which implements layer 3 and layer 2 functionality.

The controller/processor 359 can be associated with at least one memory 360 that stores program codes and data. The at least one memory 360 may be referred to as a computer-readable medium. In the UL, the controller/processor 359 provides demultiplexing between transport and logical channels, packet reassembly, deciphering, header decompression, and control signal processing to recover IP packets. The controller/processor 359 is also responsible for error detection using an ACK and/or NACK protocol to support HARQ operations.

Similar to the functionality described in connection with the DL transmission by the base station 310, the controller/processor 359 provides RRC layer functionality associated with system information (e.g., MIB, SIBs) acquisition, RRC connections, and measurement reporting; PDCP layer functionality associated with header compression/decompression, and security (ciphering, deciphering, integrity protection, integrity verification); RLC layer functionality associated with the transfer of upper layer PDUs, error correction through ARQ, concatenation, segmentation, and reassembly of RLC SDUs, re-segmentation of RLC data PDUs, and reordering of RLC data PDUs; and MAC layer functionality associated with mapping between logical channels and transport channels, multiplexing of MAC SDUs onto TBs, demultiplexing of MAC SDUs from TBs, scheduling information reporting, error correction through HARQ, priority handling, and logical channel prioritization.

Channel estimates derived by a channel estimator 358 from a reference signal or feedback transmitted by the base station 310 may be used by the TX processor 368 to select the appropriate coding and modulation schemes, and to facilitate spatial processing. The spatial streams generated by the TX processor 368 may be provided to different antennas 352 via separate transmitters 354Tx. Each transmitter 354Tx may modulate an RF carrier with a respective spatial stream for transmission.

The UL transmission is processed at the base station 310 in a manner similar to that described in connection with the receiver function at the UE 350. Each receiver 318Rx receives a signal through its respective antenna 320. Each receiver 318Rx recovers information modulated onto an RF carrier and provides the information to a RX processor 370.

The controller/processor 375 can be associated with at least one memory 376 that stores program codes and data. The at least one memory 376 may be referred to as a computer-readable medium. In the UL, the controller/processor 375 provides demultiplexing between transport and logical channels, packet reassembly, deciphering, header decompression, control signal processing to recover IP packets. The controller/processor 375 is also responsible for error detection using an ACK and/or NACK protocol to support HARQ operations.

At least one of the TX processor 368, the RX processor 356, and the controller/processor 359 may be configured to perform aspects in connection with the duplex-mode-dependent OLPC component 198 of FIG. 1.

At least one of the TX processor 316, the RX processor 370, and the controller/processor 375 may be configured to perform aspects in connection with the duplex-mode-dependent OLPC component 199 of FIG. 1.

In some aspects, of wireless communication, open loop power control may be used for boosting and/or reducing power in response to changing conditions. Depending on changing conditions and/or on a slot type, an open loop power control parameter set may be used differently. For example, a base station may determine that a transmission power of an uplink communication from a wireless device (e.g., a physical uplink shared channel (PUSCH) communication) is too low to overcome the self-interference at the base station and request and/or indicate for the wireless device (or UE) to increase a transmission power. Alternatively, or additionally, a base station may determine that a transmission power is too high (e.g., is causing cross-link interference (CLI)) and may request and/or indicate for the wireless device (or UE) to reduce the transmission power to reduce the CLI at other UEs receiving downlink (DL) transmissions. In some aspects, an open loop power control parameter may be used to control this behavior across different slot types.

In some aspects, an open loop power control parameter set that may be appropriate for transmissions associated with a first mode of operation (e.g., a full-duplex mode of operation) may not be appropriate for a second mode of operation (e.g., a half-duplex mode of operation). For example, a full duplex mode may be associated with a higher power transmission (and a first associated open loop power control parameter or parameter set) from a wireless device to overcome self-interference at a base station while a half-duplex mode of operation may be associated with a lower power transmission (and a second associated open loop power control parameter or parameter set) to avoid generating, or minimizing, CLI. However, for changes back and forth between a full-duplex mode of operation and a half-duplex mode of operation, the use of a single open loop control parameter (or parameter set) may lead to sub-optimal transmission power in at least one of the two modes of operation. For example, even if an open loop power control parameter set includes more than one power (e.g., if a PUSCH-Set is configured with more than one P0 value) rules to use these other values may not accommodate or address the switch between the modes of operation (e.g., full-duplex and/or half-duplex).

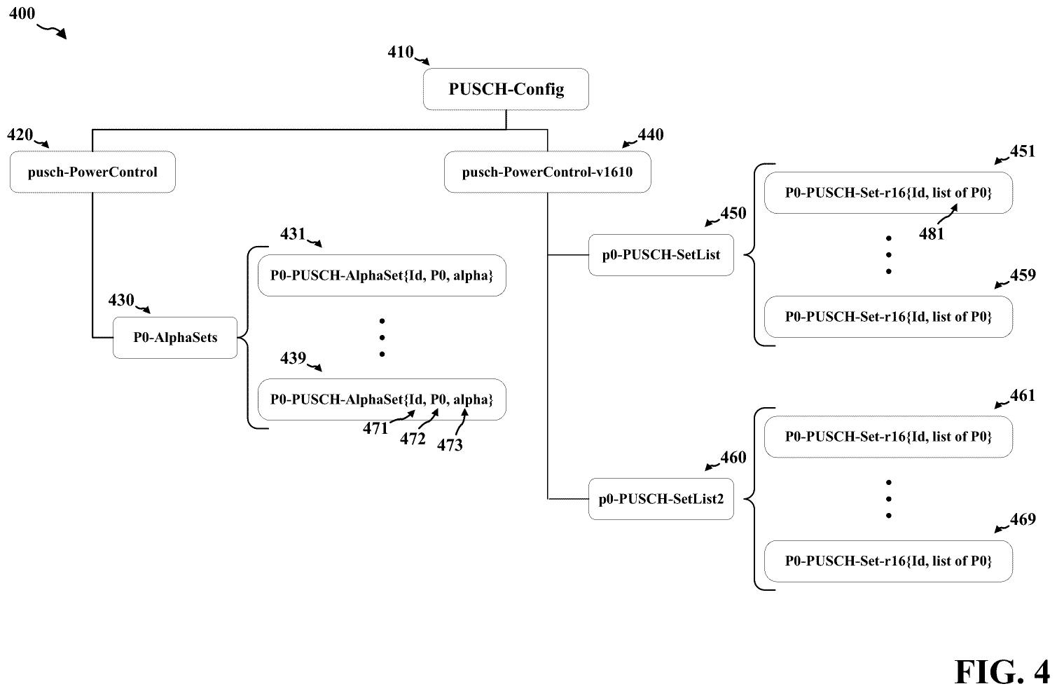

FIG. 4 is a diagram 400 illustrating a set of power control parameter set lists, sets, and values (e.g., P0 values) that may be configured for a UE. For example, a PUSCH configuration (e.g., PUSCH-Config 410) may include a first set of open loop power control parameter sets (e.g., P0-AlphaSets 430) in a first category of open loop power control parameters (e.g., pusch-PowerControl 420) and additional sets of open loop power control parameter sets (e.g., p0-PUSCH-SetList 450 and p0-PUSCH-SetList2 460) in a second category of open loop power control parameters (e.g., pusch-PowerControl-v1610 440). Each set of open loop power control parameter sets may include multiple open loop power control parameter sets (e.g., P0-AlphaSets 430 may include P0-PUSCH-AlphaSet 431 to P0-PUSCH-AlphaSet 439; p0-PUSCH-SetList 450 may include P0-PUSCH-Set-r16 451 to P0-PUSCH-Set-r16 459; and p0-PUSCH-SetList2 460 may include P0-PUSCH-Set-r16 461, P0-PUSCH-Set-r16 469). Each open loop power control parameter set (e.g., P0-PUSCH-AlphaSet 439 to P0-PUSCH-Set-r16 469) may in turn be associated with one or more parameter values (e.g., one or more values for a P0 or a first value for an alpha (a) and a second value for a P0). The one or more parameter values may be used to determine a transmission power for a PUSCH transmission from the UE.

For example, for a PUSCH transmission on an active UL BWP (b) of a carrier (f) of a serving cell (c) using a parameter set configuration with index j and a PUSCH power control adjustment with state l, a UE may determine the PUSCH transmission power P_{PUSCH,b,f,c}(i,j,q,l) as the minimum of P_{CMAX,f,c}(i) and P_{0_PUSCH b,f,c}(j)+10 Log₁₀ (2^{μ}·M_{RB,b,f,c}^{PUSCH} (i))+α_{b,f,c}(j)·PL_{b,f,c}(q_{d})+Δ_{TF,b,f,c}(i)+f_{b,f,c}(i,l), where P_{0_PUSCH b,f,c}(j) (referred to as P0 for convenience) is an open loop power control parameter value that may be signaled in DCI (e.g., in an SRS resource indicator (SRI) field) by reference to one of the open loop power control parameter sets and/or a particular parameter value in an indicated open loop power control parameter set. P_{CMAX,f,c}(i) is the UE configured maximum output power for carrier f of serving cell c in PUSCH transmission occasion i. A value may be provided to the UE for α_{b,f,c}(j). PL_{b,f,c}(q_{d}) is a downlink pathloss estimate in dB calculated by the UE using reference signal (RS) index q_{d} for the active DL BWP of carrier f of serving cell c. Δ_{TF,b,f,c}(i)=10 log₁₀ ((2^{BPRE·K}^{ₛ}−1)·β_{offset}^{PUSCH}) for Kₛ=1.25 and Δ_{TF,b,f,c}(i)=0 for Kₛ=0 where Kₛ is provided by deltaMCS for each UL BWP b of each carrier f and serving cell c. The PUSCH power control adjustment state, with state l, may be referred to as a closed loop power control parameters, and is represented as f_{b,f,c}(i,l) for active UL BWP b of carrier f of serving cell c in PUSCH transmission occasion i. P0 and α may be referred to as open loop power control parameters.

The PUSCH Pathloss Reference RS Update MAC CE may be identified by a MAC subheader with eLCID based on a table. The MAC-CE may have a variable size and include fields such as a serving cell ID, a BWP ID, T, PUSCH Pathloss Reference RS ID, C, SRI ID, and one or more reserved bits. The Serving Cell ID may be a field that indicates the identity of the Serving Cell, which contains activated PUSCH Pathloss Reference RS. The length of the field may be 5 bits, in some examples. The BWP ID field indicates a UL BWP as the codepoint of the DCI bandwidth part indicator field, which contains activated PUSCH Pathloss Reference RS. The length of the field may be 2 bits, for example. If the UE is configured with two SRS resources sets for codebook or non-codebook, in the indicated bandwidth part of the indicated Serving Cell, the T field may be set to 0, SRI ID(s) to be updated are the ones associated with the first SRS resource set, and if T is set to 1 the SRI ID(s) to be updated are the ones associated with the second SRS resource set. Otherwise, this field may be a reserved bit set to 0, in some examples. The PUSCH Pathloss Reference RS ID field may indicate the PUSCH Pathloss Reference RS ID identified by PUSCH-PathlossReferenceRS-Id, which is to be updated in the SRI PUSCH power control mappings indicated by SRI ID fields indicated in the same MAC CE. The length of the field may be 6 bits, for example. The C field indicates the presence of the additional SRI ID in the last octet of this MAC CE. If this field is set to 1, two SRI ID(s) may be present in the last octet. Otherwise only one SRI ID (i.e. the first SRI ID) may be present in the last octet. The SRI ID field indicates the SRI PUSCH power control ID identified by sri-PUSCH-PowerControlId. The length of the field may be 4 bits, for example. The R field may refer to a reserved bit, which may be set to zero.

In some aspects, the UE may use different configured open loop power control parameter values based on one or more rules. For example, if, for a first category of open loop power control sets (e.g., P0-AlphaSets 430), the UE is provided more than one open loop power control parameter set (e.g., P0-PUSCH-AlphaSet 431 to P0-PUSCH-AlphaSet 439 each associated with an ID such as ID 471, a P0 value 472, and an alpha value 473 associated with P0-PUSCH-AlphaSet 439), control information may be provided to indicate a particular open loop power control parameter set to use to determine a power for a particular PUSCH transmission. The control information may be transmitted in an SRI field (to indicate an open loop power control parameter set ID) and, in some aspects, an open loop power control parameter set indication field (to indicate the use of a power value from an open loop power control parameter set associated with the second category of open loop power control parameters), of DCI.

For example, if the UE is provided by SRI-PUSCH-PowerControl more than one values of p0-PUSCH-AlphaSetId and if a DCI format scheduling the PUSCH transmission includes an SRI field, the UE obtains a mapping from sri-PUSCH-PowerControlId in SRI-PUSCH-PowerControl between a set of values for the SRI field in the DCI format [5, TS 38.212] and a set of indexes provided by p0-PUSCH-AlphaSetId that map to a set of P0-PUSCH-AlphaSet values and determines the value of P_{O_UE_PUSCH,b,f,c}(j) from the p0-PUSCH-AlphaSetId value that is mapped to the SRI field value. If the UE is provided by SRI-PUSCH-PowerControl more than one values of p0-PUSCH-AlphaSetId and the DCI format also includes an open-loop power control parameter set indication field and a value of the open-loop power control parameter set indication field is ‘l’ and if the DCI format scheduling the PUSCH transmission includes an SRI field, the UE determines a value of P_{O_UE_PUSCH,b,f,c}(j) from a first value in P0-PUSCH-Set with a p0-PUSCH-SetId value mapped to the SRI field value.

If DCI does not include an SRI field and the DCI includes an open loop power control parameter set indication field, the UE may determine a value of P0 based on the value indicated in the open loop power control parameter set indication field. For example, if the value indicated in the open loop power control parameter set indication field is a first value (‘0’ or ‘00’) (or if the DCI does not include an open loop power control parameter set indication field), the UE may use a value of P0 from a first open loop power control parameter set associated with the first category of open loop power control parameters (e.g., P0-PUSCH-AlphaSet 431). If the value indicated in the open loop power control parameter set indication field is a second value (‘1’ or ‘01’), the UE may use a first value of P0 from a list of P0 values (e.g., list of P0 481) from a second open loop power control parameter set associated with the second category of open loop power control parameters (e.g., P0-PUSCH-Set-r16 451). In some aspects, if the value indicated in the open loop power control parameter set indication field is a second value (‘10’), the UE may use a second value of P0 from a list of P0 values (e.g., list of P0 481) from a second open loop power control parameter set associated with the second category of open loop power control parameters (e.g., P0-PUSCH-Set-r16 451).

For example, if P0-PUSCH-Set is provided to the UE and the DCI format includes an open-loop power control parameter set indication field, the UE determines a value of P_{O_UE_PUSCH,b,f,c}(j) from: a first P0-PUSCH-AlphaSet in p0-AlphaSets if a value of the open-loop power control parameter set indication field is ‘O’ or, a first value in P0-PUSCH-Set with the lowest p0-PUSCH-SetID value if a value of the open-loop power control parameter set indication field is ‘1’ or ‘01’, a second value in P0-PUSCH-Set with the lowest p0-PUSCH-SetID value if a value of the open-loop power control parameter set indication field is ‘10’, or else, the UE determines P_{O_UE_PUSCH,b,f,c}(j) from the value of the first P0-PUSCH-AlphaSet in p0-AlphaSets.

As can be seen from the examples above, the range of P0 values that may be configured and indicated using the SRI field and the open loop power control parameter set indication field may be limited. For example, the combination of the SRI field and the open loop power control parameter set indication field may indicate one of up to three values (a first value from the P0-PUSCH-AlphaSet 431, a second value from the P0-PUSCH-Set-r16 451, or a third value from the P0-PUSCH-Set-r16 451). However, for a UE dynamically switching between resources for, or associated with, a first, full-duplex mode of operation and a second, half-duplex mode of operation, a set of three candidate P0 values may not be sufficient to address the different powers useful for the different modes of operation.

Open loop power control may be used for power boosting, and can be used to reduce the power as well. By enabling the open loop power control parameter set to be used differently for different slot types, the aspects presented herein enable a base station to increase transmission power of PUSCH to overcome self-interference or to reduce the transmission power for PUSCH to reduce CLI at other UEs receiving DL transmissions that overlap in time with the PUSCH (e.g., for full-duplex slots). Aspects presented herein enable an open loop power control parameter to be used to control such transmission power behavior across different slot types, including when the half-duplex and full-duplex transmissions occur on the same spatial filter (SRI indication). Aspects presented herein enable the network to signal open loop power control parameters differently, e.g., for different duplex modes. The added flexibility for the network to signal the open loop power control parameter can improve wireless communication by enabling the network to more flexibly mitigate various types of interference.

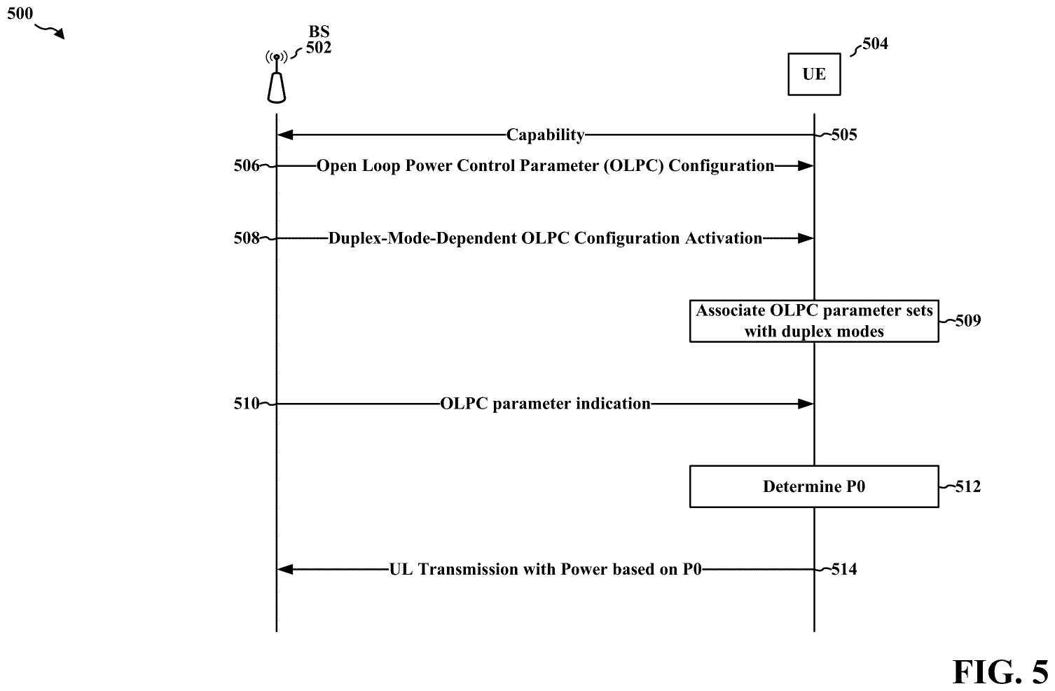

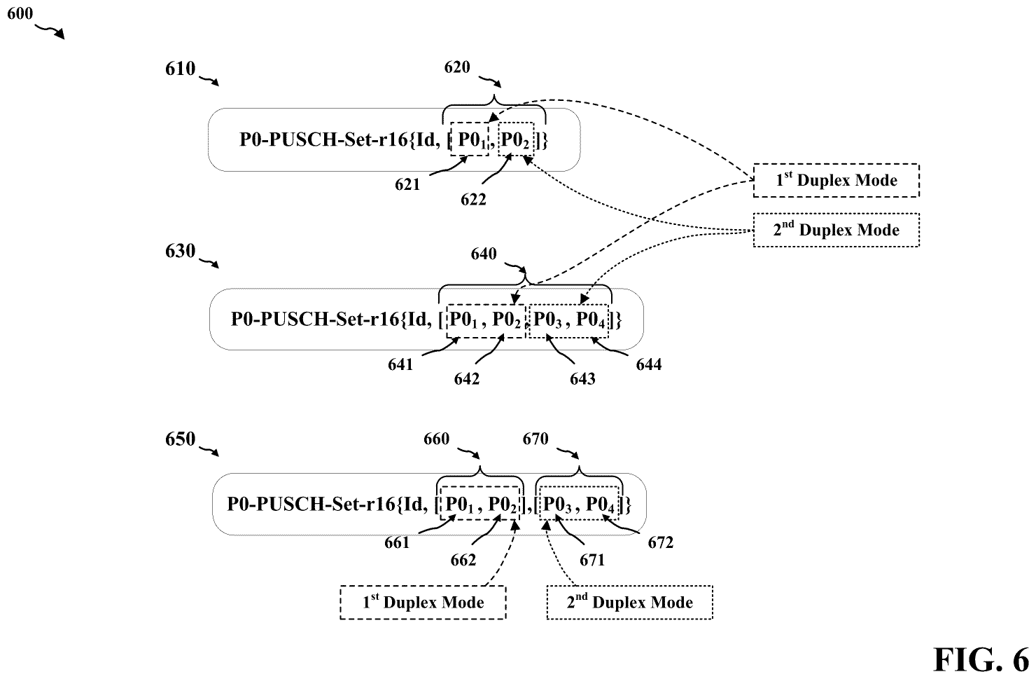

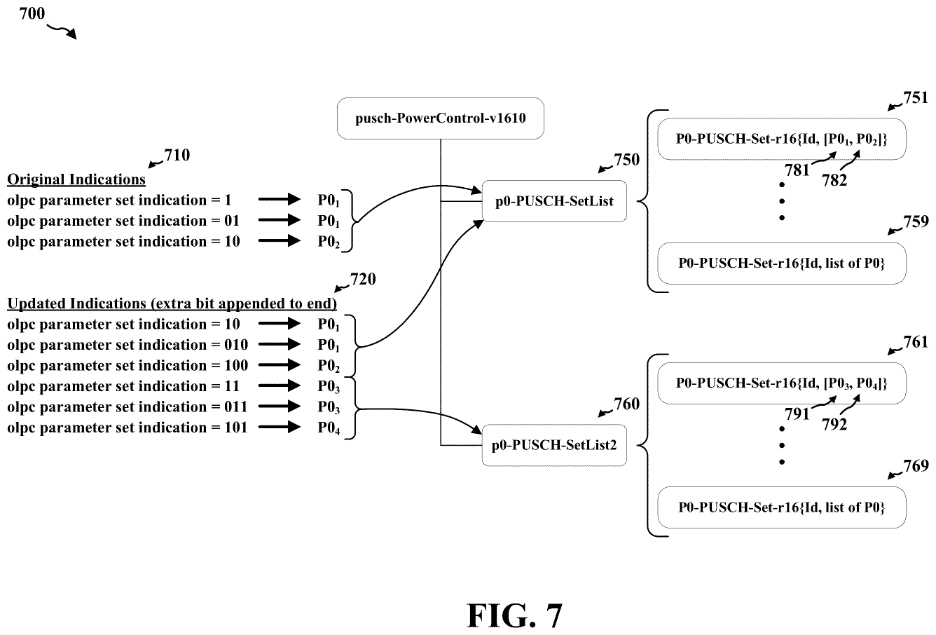

FIG. 5 is a call flow diagram 500 of a method for open loop power control parameter indication in accordance with some aspects of the disclosure. FIG. 6 is a diagram 600 illustrating possible configurations of open loop power control parameter sets in accordance with some aspects of the disclosure. FIG. 7 is a diagram 700 illustrating a possible configuration of open loop power control parameter sets and corresponding indications of particular open loop power values in accordance with some aspects of the disclosure.

Call flow diagram 500 illustrates a base station 502 (e.g., as an example of a network device or network node) in communication with a UE 504 (e.g., as an example of a wireless device). The aspects performed by the base station 502 may be performed by the base station in aggregation or by one or more components of a disaggregated base station. The functions ascribed to the base station 502, in some aspects, may be performed by one or more components of a network entity, a network node, or a network device (a single network entity/node/device or a disaggregated network entity/node/device as described above in relation to FIG. 1). Similarly, the functions ascribed to the UE 504, in some aspects, may be performed by one or more components of a wireless device supporting communication with a network entity/node/device. Accordingly, references to “transmitting” in the description below may be understood to refer to a first component of the base station 502 (or the UE 504) outputting (or providing) an indication of the content of the transmission to be transmitted by a different component of the base station 502 (or the UE 504). Similarly, references to “receiving” in the description below may be understood to refer to a first component of the base station 502 (or the UE 504) receiving a transmitted signal and outputting (or providing) the received signal (or information based on the received signal) to a different component of the base station 502 (or the UE 504).

The base station 502 may transmit, and a UE 504 may receive, open loop power control parameter configuration 506. In some aspects, as shown at 505, the UE 504 may indicate support for (or a capability for) an open loop power control parameter configuration having different values for different duplex modes prior to receiving the configuration 506. In some aspects, the open loop power control parameter configuration 506 may include a configuration of two or more open loop power values (e.g., P0 values) in one or more open loop power control parameter sets (or set lists). Each open loop power value (e.g., P0 value) (or associated open loop power control parameter set) of the two or more open loop power values, in some aspects, may be associated with a different duplex mode (e.g., a first of the two or more open loop power values may be associated with a full-duplex mode while a second of the two or more open loop power values may be associated with a half-duplex mode). In some aspects, the one or more open loop power control parameter sets may include two open loop power control parameter sets (each including one or more open loop power values). For example, referring to FIG. 4, the open loop power control parameter configuration 506 may include a first open loop control parameter set associated with a first open loop control parameter set list (e.g., one of P0-PUSCH-Set-r16 451 to P0-PUSCH-Set-r16 459 associated with p0-PUSCH-SetList 450) and a second open loop control parameter set associated with a second open loop control parameter set list (e.g., one of P0-PUSCH-Set-r16 461 to P0-PUSCH-Set-r16 469 associated with p0-PUSCH-SetList2 460).

In some aspects, the association may be a correspondence such that a first open loop power value for an UL (e.g., PUSCH) transmission during a particular slot may be selected based on a duplex mode associated with the particular slot. In other aspects, the association may reflect an expected use case (a first open loop power value may be expected to be useful for a particular duplex mode) that may be defied based on an explicit indication for an open loop power associated with the other duplex mode to be used despite normally being associated with a different duplex mode. For example, a first P0 value may be associated with (or expected to be useful for) a full-duplex mode, but may be indicated for use in determining a transmission power during a half-duplex slot.

In some aspects, the two or more open loop power values may include two open loop power values and the one or more open loop power control parameter sets may include one open loop power control parameter set including a first open loop power value associated with a half-duplex mode and a second open loop power value associated with a full-duplex mode. For example, referring to FIGS. 4 and 6, the open loop power control parameter configuration 506 may include open loop power control parameter set 451 or open loop power control parameter set 610 that may include a list of P0 481 or a list of P0 values 620 that includes a first P0 value (e.g., P0₁ 621) associated with the full-duplex mode and a second P0 value (e.g., P0₂ 622) associated with the half-duplex mode.

The two or more open loop power values, in some aspects, may include four open loop power values. In some aspects, the one or more open loop power control parameter sets may include one open loop power control parameter set (e.g., open loop power control parameter set 630 including a list of P0 values 640). The open loop power control parameter set, in some aspects, may include a first pair of open loop power values (e.g., P0₁ 641 and P0₂ 642) associated with a half-duplex mode and a second pair of open loop power values (e.g., P0₃ 643 and P0₄ 644) associated with a full-duplex mode. The one or more open loop power control parameter sets, in some aspects, may include one open loop power control parameter set (e.g., open loop power control parameter set 650) including a first list of open loop power values (e.g., the first list of P0 values 660 including P0 value 661 and P0 value 662) associated with a half-duplex mode and a second list of open loop power values (e.g., the second list of P0 values 670 including P0 value 671 and P0 value 672) associated with a full-duplex mode.

In some aspects, the one or more open loop power control parameter sets may include two open loop power control parameter sets including a first open loop power control parameter set associated with a first duplex mode and including a first open loop power value of the two or more open loop power values and an additional parameter value used for open loop power control and a second open loop power control parameter set associated with a second duplex mode and including at least one additional open loop power value of the two or more open loop power values. For example, referring to FIG. 4, the open loop power control parameter configuration 506 may include a first open loop power control parameter set (e.g., P0-PUSCH-AlphaSet 431 or P0-PUSCH-AlphaSet 439) including a first open loop power value (e.g., P0 472) of the two or more open loop power values and an additional parameter value (e.g., an alpha value 473) used for open loop power control (e.g., associated with the α_{b,f,c}(j) term in the equation for PUSCH transmission power discussed above). The open loop power control parameter configuration 506 may include a second open loop power control parameter set (e.g., P0-PUSCH-Set-r16 451 or P0-PUSCH-Set-r16 459) including a second open loop power value (e.g., a P0 value in the list of P0 481) of the two or more open loop power values.

In some aspects, the one or more open loop power control parameter sets may include two open loop power control parameter sets including a first open loop power control parameter set configured for a first transmission reception point (TRP) of the base station 502 (e.g., a network device associated with an uplink transmission from the UE 504) and a second open loop power control parameter set configured for a second TRP of the base station 502 (e.g., the network device). In some aspects, the first open loop power control parameter set may be associated with a half-duplex mode of the first TRP and the second open loop power control parameter set may be associated with a full-duplex mode of the first TRP. For example, referring to FIG. 4, the open loop power control parameter configuration 506 may include a first open loop power control parameter set list (e.g., P0-PUSCH-SetList 450) including one or more open loop power control parameter sets (e.g., P0-PUSCH-Set-r16 451 or P0-PUSCH-Set-r16 459) that may be associated with a first TRP and/or a first duplex mode (e.g., a half-duplex mode) of the first TRP. The open loop power control parameter configuration 506 may further include a second open loop power control parameter set list (e.g., P0-PUSCH-SetList2 460) including one or more open loop power control parameter sets (e.g., P0-PUSCH-Set-r16 461 or P0-PUSCH-Set-r16 469) that may be associated with at least one of a second TRP and/or a second duplex mode (e.g., a full-duplex mode) of the first TRP.

The base station 502 may transmit, and the UE 504 may receive, a duplex-mode-dependent OLPC configuration indication 508. The duplex-mode-dependent OLPC configuration indication 508, in some aspects, may be used to indicate for the UE 504 to switch from a first association between the first and second open loop power control parameter set lists and the first TRP and the second TRP to a second association between the first and second open loop power control parameter set lists and the first duplex mode of the first TRP and the second duplex mode of the first TRP. In some aspects, the base station 502 may transmit, and the UE 504 may receive, the duplex-mode-dependent OLPC configuration indication 508 (e.g., an activation indication) via at least one of an RRC configuration, a MAC-CE, or DCI. The duplex-mode-dependent OLPC configuration indication 508, in some aspects, may indicate one of a time for reverting to associating the first open loop power control parameter set with the first TRP and the second open loop power control parameter set with the second TRP. In some aspects, the time for reverting to associating the first open loop power control parameter set with the first TRP and the second open loop power control parameter set with the second TRP may be indicated to be based on one or more of a known time (e.g., at a particular time defined locally or globally), a duration (e.g., after a particular number of symbols, slots, frames, or seconds), based on receiving a deactivation indication (e.g., a subsequent indication similar to duplex-mode-dependent OLPC configuration indication 508 indicating to return to a multi-TRP mode for OLPC parameter selection). Based on the duplex-mode-dependent OLPC configuration indication 508, the UE 504 may, at 509, associate the first and second open loop power control parameter set lists with the first duplex mode of the first TRP and the second duplex mode of the first TRP, respectively.

After configuring (and activating and/or associating) the two or more open loop power values (e.g., P0 values) in one or more open loop power control parameter sets (or set lists) via the open loop power control parameter configuration 506, the base station 502 may transmit, and the UE 504 may receive, an OLPC parameter indication 510. In some aspects, the OLPC parameter indication 510 may include 0, 1, 2, or 3 bits. In some aspects, the indication may be included in DCI and may include a first indication of a first open loop power control parameter set of the one or more open loop power control parameter sets indicating the open loop power value to use for the uplink transmission. In some aspects, the indication may include a set of bits in an open loop control parameter set indication field. The one or more open loop power control parameter sets may include two open loop power control parameter sets, and the set of bits may include at least one bit included in the indication that indicates one open loop power control parameter set of the two open loop power control parameter sets to use to determine the open loop power value and at least one set of one or more bits indicating the open loop power value within the one open loop power control parameter set indicated by the at least one bit. For example, referring to FIG. 7, the set of bits (e.g., in an indication in the set of updated indications 720) may include a set of most significant bits (MSB) (or, in some aspects, least significant bits (LSB)) indicating an open loop power value (e.g., P0₁ 781 or P0₂ 782 and/or P0₃ 791 or P0₄ 792) within an open loop power control parameter set and an LSB (or, in some aspects, an MSB) indicating the open loop power control parameter set to use to determine the open loop power value (e.g., the P0 value). The MSB may maintain a previously defined mapping between bit values and selected P0 values from a list of two P0 values (e.g., the mapping illustrated in the set of original indications 710) such that once the open loop power control parameter set is identified by the LSB, the selection, determination, and/or identification of the P0 value from a list of P0 values is unchanged. While a first open loop power control parameter set list and/or set (P0-PUSCH-SetList 750 and/or P0-PUSCH-Set-r16 751 or P0-PUSCH-Set-r16 759) may be associated with a first duplex mode (e.g., may be configured based on a transmission power expected to be useful for the first duplex mode) and a second open loop power control parameter set list and/or set (P0-PUSCH-SetList2 760 and/or P0-PUSCH-Set-r16 761 or P0-PUSCH-Set-r16 769) may be associated with a second duplex mode (e.g., may be configured based on a transmission power expected to be useful for the second duplex mode), the set of bits in the OLPC parameter indication 510 may allow the use of either the first or the second open loop power control parameter set with either, or both, of the duplex modes. While not illustrated in diagram 700, a bit value of ‘0’ or ‘00’ may be used to indicate the use of a P0 value from a different open loop power control parameter set (or set list) such as one of P0-PUSCH-AlphaSet 431 to P0-PUSCH-AlphaSet 439 (or P0-AlphaSets 430) and the additional bit (e.g., the added LSB or MSB) may be ignored or repurposed.

In some aspects, the indication may be included in DCI and may include an indication of a first (or second) duplex mode associated with a first (or second) open loop power control parameter set of the one or more open loop power control parameter sets (e.g., configured via open loop power control parameter configuration 506) indicating the open loop power value to use for the uplink transmission. The OLPC parameter indication 510 indicating the open loop power value, in some aspects, may include one of a first indication of the half-duplex mode or a second indication of the full-duplex mode associated with a slot including an UL transmission (a scheduled and/or subsequent PUSCH transmission). In some aspects, the OLPC parameter indication 510 may be received via DCI associated at the wireless device with the first duplex mode (e.g., a full-duplex, or half-duplex, mode). The DCI may be configured to omit a set of one or more bits associated with the OLPC parameter indication 510 that are configured to indicate an open loop power value within an open loop power control parameter set associated with the second duplex mode or the DCI may be configured to include a known value of the set of one or more bits associated with the OLPC parameter indication 510 that are configured to indicate an open loop power value within the open loop power control parameter set associated with the second duplex mode (e.g., for the UE 504 to use as reference bits to improve a decoding performance).

Based on the open loop power control parameter configuration 506, the duplex-mode-dependent OLPC configuration indication 508, and the OLPC parameter indication 510, the UE 504, in some aspects, may, at 512, determine a P0 value to use for an UL transmission (e.g., a PUSCH transmission). For example, if the open loop power control parameter configuration 506 indicates the configuration illustrated in diagrams 400 and 700, the UE 504 may determine, at 512, the P0 value based on the set of bits (the two, or three, bits) included in the open loop control parameter set indication field, where the P0 value may be selected from one of an open loop power control parameter set (e.g., P0-PUSCH-AlphaSet 431) in a first category of open loop power control parameters or from one of two open loop power control parameter sets (e.g., P0-PUSCH-Set-r16 451/751 or P0-PUSCH-Set-r16 461/761) in a second category of open loop power control parameters as described in relation to the set of original indications 710 and the set of updated indications 720.

If the open loop power control parameter configuration 506 indicates any of the configurations illustrated in diagram 600 or any configuration for which open loop power control parameter sets correspond to (or are identified with) particular duplex modes, the OLPC parameter indication 510 may indicate a duplex mode that determines (or identifies) an open loop power control parameter set to use. If there are multiple P0 values configured in an open loop power control parameter indicated in the OLPC parameter indication 510, the OLPC parameter indication 510 may further include a set of bits (e.g., 1 or 2 bits as in the set of original indications 710) in an open loop control parameter set indication field to select a particular P0 value. As illustrated in diagram 600, the duplex mode indicated in OLPC parameter indication 510, in some aspects, may further be used to determine, as part of determining a P0 value to use for an UL transmission at 512, one of (1) which P0 value (e.g., P0₁ 621 or P0₂ 622) to use from a list of P0 values (e.g., for an open loop power control parameter set configured with a single list of P0 values 620 like open loop power control parameter set 610), (2) which subset of P0 values (e.g., a first subset of P0 values including P0₁ 641 and P0₂ 642 or a second subset of P0 values including P0₃ 643 and P0₄ 644) to use within a list of P0 values (e.g., for an open loop power control parameter set configured with a single, expanded list of P0 values 640 like open loop power control parameter set 630) to determine a P0 value, or (3) which list of P0 values (e.g., the first list of P0 values 660 or the second list of P0 values 670) to use within a set of lists of P0 values (e.g., for an open loop power control parameter set configured like open loop power control parameter set 650) to determine a P0 value.

In some aspects, the OLPC parameter indication 510 may include a set of bits in an open loop control parameter set indication field to maintain an expected format bit (or field) alignment. However, if the duplex type associated with the OLPC parameter indication 510 does not use the bits of (or the information included in) the open loop control parameter set indication field to determine the P0 value, the bits of the open loop control parameter set indication field may be ignored or used for other purposes (e.g., improving a decoding performance). For example, if the slot type associated with a particular OLPC parameter indication 510 (or DCI including the OLPC parameter indication 510) is not known before receiving the OLPC parameter indication 510 (or DCI), the base station 502 may transmit the OLPC parameter indication 510 including a set of bits in the open loop control parameter set indication field to maintain an expected bit alignment, however, if the associated slot is indicated to be of a first duplex mode that does not use the set of bits in the open loop control parameter set indication field to determine the P0 value to use for an associated PUSCH transmission, the bits may be ignored or may be assumed to take on a known (e.g., pre-configured) value to improve a decoding performance. Accordingly, based on the duplex mode indicated by the OLPC parameter indication 510, the UE 504 may, at 512, determine the P0 value to sue for an associated UL transmission.

In some aspects, if the slot type associated with a particular OLPC parameter indication 510 (or DCI including the OLPC parameter indication 510) is known before receiving the OLPC parameter indication 510 (or DCI) and does not use the set of bits in the open loop control parameter set indication field to determine, select, and/or identify the P0 value for the associated PUSCH transmission, the base station 502 may omit the set of bits in the open loop control parameter set indication field with the UE 504 expecting this omission and performing a decoding based on a bit alignment not including the set of bits of the open loop control parameter set indication field. For example, the UE 504 may obtain information (e.g., a slot format and k_min value) indicating that an associated PUSCH will be scheduled during a slot associated with a first duplex mode (e.g., a full-duplex slot) such as where there is no slot associated with the second duplex mode (e.g., a half-duplex slot) available within a time window within which the DCI could schedule the PUSCH. The set of bits (with a known set of values) may be included even if the duplex type is known before receiving the OLPC parameter indication 510 to improve a decoding performance as discussed above. Accordingly, based on the duplex mode indicated by the OLPC parameter indication 510, the UE 504 may, at 512, determine the P0 value to sue for an associated UL transmission.

The UE 504 may then transmit, and the base station 502 may receive, an UL transmission 514 (e.g., a PUSCH transmission) with a power based on the P0 value determined at 512.

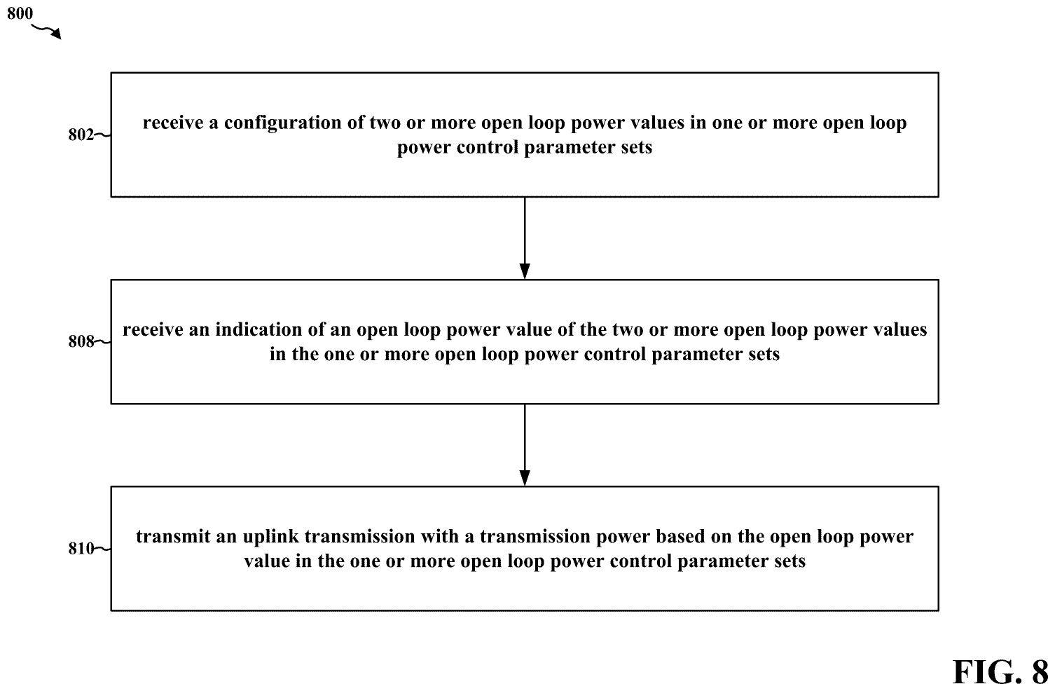

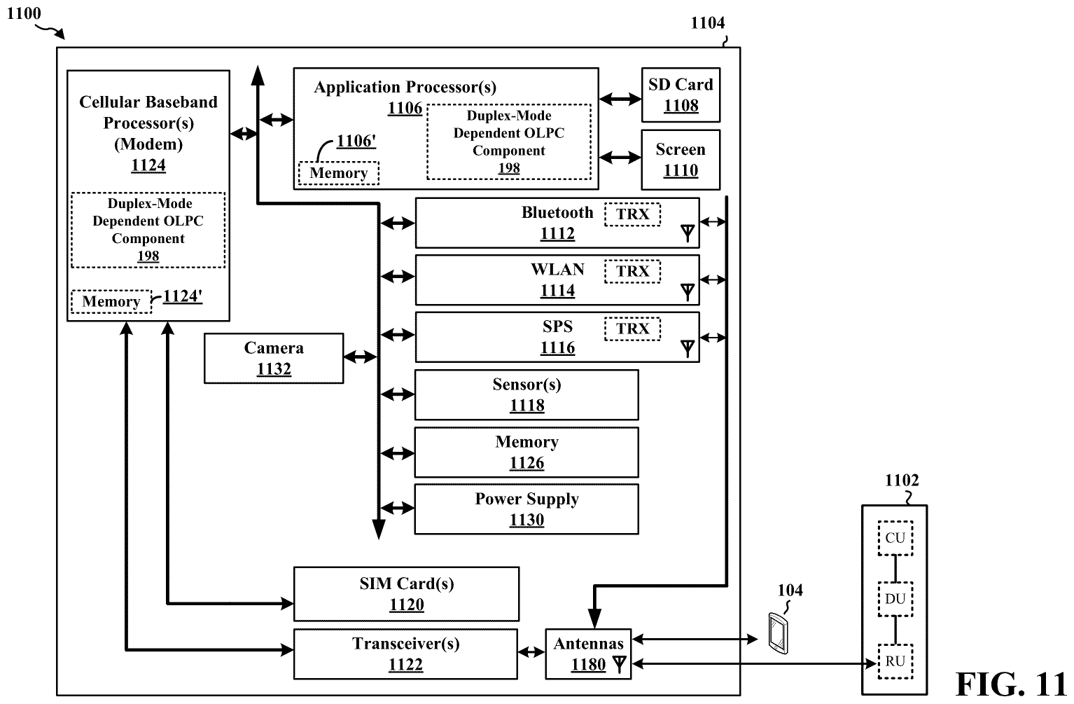

FIG. 8 is a flowchart 800 of a method of wireless communication. The method may be performed by a wireless device such as a UE (e.g., the UE 104, 504; the apparatus 1104). At 802, the UE may receive a configuration of two or more open loop power values in one or more open loop power control parameter sets. In some aspects, each open loop power value of the two or more open loop power values may be associated with a different duplex mode. For example, 802 may be performed by application processor(s) 1106, cellular baseband processor(s) 1124, transceiver(s) 1122, antenna(s) 1180, and/or duplex-mode-dependent OLPC component 198 of FIG. 11. For example, referring to FIG. 5, the UE 504 may receive open loop power control parameter configuration 506.

In some aspects, the UE may receive an activation indication to associate a first open loop power control parameter set with a half-duplex mode of the first TRP and a second open loop power control parameter set with the full-duplex mode of the first TRP. In some aspects, the activation may be received via at least one of an RRC configuration, a MAC-CE, or DCI. The activation indication, in some aspects, may further indicate one of a time for reverting to associating the first open loop power control parameter set with a first TRP and the second open loop power control parameter set with a second TRP. In some aspects, the time for reverting to associating the first open loop power control parameter set with the first TRP and the second open loop power control parameter set with the second TRP may be indicated to be based on one or more of a known time, a duration, or receiving a deactivation indication. For example, referring to FIG. 5, the UE 504 may receive duplex-mode-dependent OLPC configuration indication 508.

In some aspects, the UE may associate the first open loop power control parameter set with the half-duplex mode of the first TRP and the second open loop power control parameter set with the full-duplex mode of the first TRP. Referring to FIG. 5, for example, the UE 504 may, at 509, associate the first and second open loop power control parameter set lists with the first duplex mode of the first TRP and the second duplex mode of the first TRP, respectively.

At 808, the UE may receive an indication of an open loop power value of the two or more open loop power values in the one or more open loop power control parameter sets. For example, 808 may be performed by application processor(s) 1106, cellular baseband processor(s) 1124, transceiver(s) 1122, antenna(s) 1180, and/or duplex-mode-dependent OLPC component 198 of FIG. 11. In some aspects, the indication may include a set of bits in an open loop control parameter set indication field. The indication, in some aspects, may be an indication of a duplex mode. For example, referring to FIG. 5, the UE 504 may receive OLPC parameter indication 510.

At 810, the UE may transmit an uplink transmission with a transmission power based on the open loop power value in the one or more open loop power control parameter sets. For example, 810 may be performed by application processor(s) 1106, cellular baseband processor(s) 1124, transceiver(s) 1122, antenna(s) 1180, and/or duplex-mode-dependent OLPC component 198 of FIG. 11. In some aspects, the open loop power value may be determined by the UE based on the indication received at 808. Referring to FIG. 5, for example, the UE 504 may transmit the UL transmission 514.

In some aspects, the indication received at 808 may include a set of bits in an open loop control parameter set indication field and the one or more open loop power control parameter sets configured in association with the configuration received at 802 may include two open loop power control parameter sets. In some aspects, the set of bits may include at least one bit included in the indication that indicates one open loop power control parameter set of the two open loop power control parameter sets to use to determine the open loop power value and at least one set of one or more bits indicating the open loop power value within the one open loop power control parameter set indicated by the at least one bit. For example, referring to FIG. 7, the configuration received at 802 may include a configuration of a first open loop power control parameter set (e.g., P0-PUSCH-Set-r16 751) and a second open loop power control parameter set (e.g., P0-PUSCH-Set-r16 761). The indication received at 808, in some aspects, may include one of the set of updated indications 720.

The configuration received at 802, in some aspects, may include two or more open loop power values, and the one or more open loop power control parameter sets may include one open loop power control parameter set including a first open loop power value associated with a half-duplex mode and a second open loop power value associated with a full-duplex mode. The indication received at 808, in some aspects, may include one of a first indication of the half-duplex mode or a second indication of the full-duplex mode associated with a slot including the uplink transmission, and transmitting the uplink transmission at 810 may include one of transmitting the uplink transmission with the transmission power based on the first open loop power value for the uplink transmission as indicated by the first indication or transmitting the uplink transmission with the transmission power based on the second open loop power value for the uplink transmission as indicated by the second indication.

The configuration received at 802, in some aspects, may include four open loop power values and the one or more open loop power control parameter sets may include one open loop power control parameter set including a first pair of open loop power values associated with a half-duplex mode and a second pair of open loop power values associated with a full-duplex mode. The indication of the open loop power value received at 808 may include one of a first indication of the half-duplex mode or a second indication of the full-duplex mode associated with a slot including the uplink transmission, and transmitting the uplink transmission at 810 may include one of transmitting the uplink transmission with the transmission power based on one open loop power value of the first pair of open loop power values as indicated by the first indication or transmitting the uplink transmission with the transmission power based on one open loop power value of the second pair of open loop power values as indicated by the second indication.

The configuration received at 802, in some aspects, may include four open loop power values and the one or more open loop power control parameter sets may include one open loop power control parameter set including a first list of open loop power values associated with a half-duplex mode and a second list of open loop power values associated with a full-duplex mode. The indication of the open loop power value received at 808 may include one of a first indication of a half-duplex mode or a second indication of a full-duplex mode associated with a slot including the uplink transmission. In some aspects, transmitting the uplink transmission at 810 may include one of transmitting the uplink transmission with the transmission power based on one open loop power value of the first list of open loop power values for the uplink transmission as indicated by the first indication or transmitting the uplink transmission with the transmission power based on one open loop power value of the second list of open loop power values for the uplink transmission as indicated by the second indication.

The configuration received at 802, in some aspects, may include four open loop power values and the one or more open loop power control parameter sets may include two open loop power control parameter sets including a first open loop power control parameter set configured for a first TRP of a network device associated with the uplink transmission and a second open loop power control parameter set configured for a second TRP of the network device. In some aspects, the first open loop power control parameter set may be associated with a half-duplex mode of the first TRP and the second open loop power control parameter set may be associated with a full-duplex mode of the first TRP. In some aspects, the activation indication may be received based on the configuration received at 802. Based on the configuration received at 802 and the activation indication, the UE may associate the first open loop power control parameter set with the half-duplex mode of the first TRP and the second open loop power control parameter set with the full-duplex mode of the first TRP. The indication of the open loop power value received at 808, in some aspects, may include one of a first indication of the half-duplex mode or a second indication of the full-duplex mode associated with a slot including the uplink transmission. Transmitting the uplink transmission at 810, in some aspects, may include one of transmitting the uplink transmission with the transmission power based on one open loop power value of the first open loop power control parameter set for the uplink transmission as indicated by the first indication or transmitting the uplink transmission with the transmission power based on one open loop power value of the second open loop power control parameter set for the uplink transmission as indicated by the second indication.

The configuration received at 802, in some aspects, may include two open loop power control parameter sets including a first open loop power control parameter set associated with a first duplex mode and including a first open loop power value of the two or more open loop power values and an additional parameter value used for open loop power control and a second open loop power control parameter set associated with a second duplex mode and including at least one additional open loop power value of the two or more open loop power values. The indication of the open loop power value received at 808, in some aspects, may include one of a first indication of the first duplex mode or a second indication of the second duplex mode associated with a slot including the uplink transmission. In some aspects, receiving the indication at 808 may include receiving the first indication via DCI associated at the UE with the first duplex mode and the DCI includes one of the first indication omitting the one or more bits associated with the indication that are configured to indicate an open loop power value in the second open loop power control parameter set or the first indication with a known value of the one or more bits associated with the indication that are configured to indicate an open loop power value in the second open loop power control parameter set. In some aspects, transmitting the uplink transmission at 810 may include one of transmitting the uplink transmission with the transmission power based on the first open loop power value of the first open loop power control parameter set for the uplink transmission as indicated by the first indication, where determining to use the first open loop power value comprises ignoring one or more bits associated with the indication that are configured to indicate an open loop power value in the second open loop power control parameter set or transmitting the uplink transmission with the transmission power based on one open loop power value of the at least one additional open loop power value for the uplink transmission as indicated by the second indication.

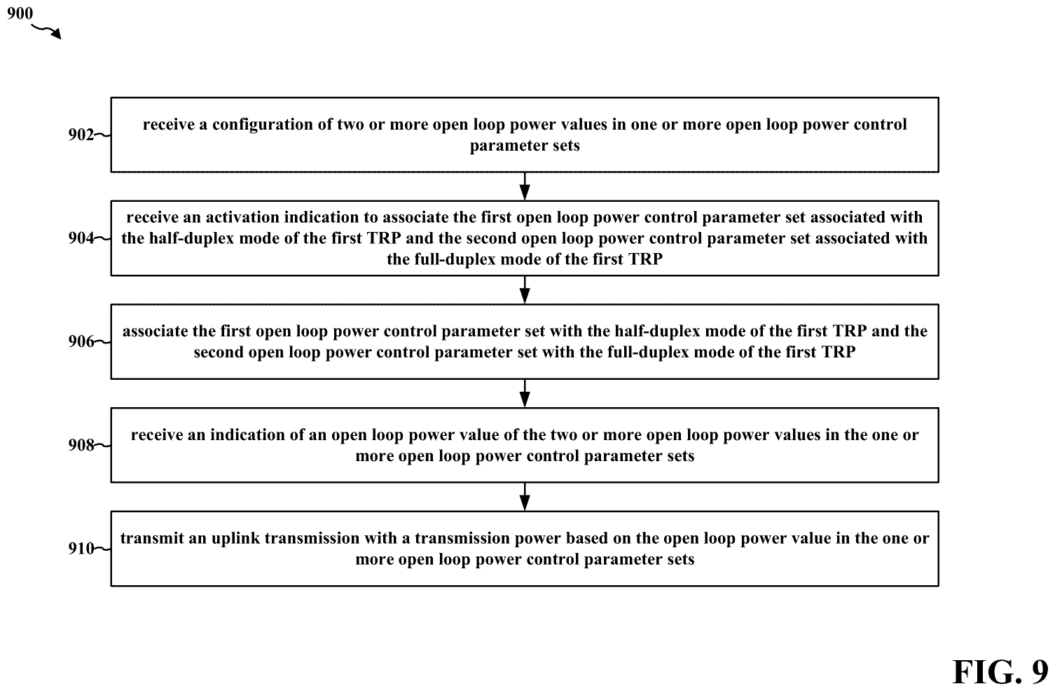

FIG. 9 is a flowchart 900 of a method of wireless communication. The method may be performed by a wireless device such as a UE (e.g., the UE 104, 504; the apparatus 1104). At 902, the UE may receive a configuration of two or more open loop power values in one or more open loop power control parameter sets. In some aspects, each open loop power value of the two or more open loop power values may be associated with a different duplex mode. For example, 902 may be performed by application processor(s) 1106, cellular baseband processor(s) 1124, transceiver(s) 1122, antenna(s) 1180, and/or duplex-mode-dependent OLPC component 198 of FIG. 11. For example, referring to FIG. 5, the UE 504 may receive open loop power control parameter configuration 506.

At 904, the UE may receive an activation indication to associate a first open loop power control parameter set with a half-duplex mode of the first TRP and a second open loop power control parameter set with the full-duplex mode of the first TRP. In some aspects, the activation may be received via at least one of an RRC configuration, a MAC-CE, or DCI. For example, 904 may be performed by application processor(s) 1106, cellular baseband processor(s) 1124, transceiver(s) 1122, antenna(s) 1180, and/or duplex-mode-dependent OLPC component 198 of FIG. 11. The activation indication, in some aspects, may further indicate one of a time for reverting to associating the first open loop power control parameter set with a first TRP and the second open loop power control parameter set with a second TRP. In some aspects, the time for reverting to associating the first open loop power control parameter set with the first TRP and the second open loop power control parameter set with the second TRP may be indicated to be based on one or more of a known time, a duration, or receiving a deactivation indication. For example, referring to FIG. 5, the UE 504 may receive duplex-mode-dependent OLPC configuration indication 508.

At 906, the UE may associate the first open loop power control parameter set with the half-duplex mode of the first TRP and the second open loop power control parameter set with the full-duplex mode of the first TRP. For example, 906 may be performed by application processor(s) 1106, cellular baseband processor(s) 1124, transceiver(s) 1122, antenna(s) 1180, and/or duplex-mode-dependent OLPC component 198 of FIG. 11. Referring to FIG. 5, for example, the UE 504 may, at 509, associate the first and second open loop power control parameter set lists with the first duplex mode of the first TRP and the second duplex mode of the first TRP, respectively.

At 908, the UE may receive an indication of an open loop power value of the two or more open loop power values in the one or more open loop power control parameter sets. For example, 908 may be performed by application processor(s) 1106, cellular baseband processor(s) 1124, transceiver(s) 1122, antenna(s) 1180, and/or duplex-mode-dependent OLPC component 198 of FIG. 11. In some aspects, the indication may include a set of bits in an open loop control parameter set indication field. The indication, in some aspects, may be an indication of a duplex mode. For example, referring to FIG. 5, the UE 504 may receive OLPC parameter indication 510.

At 910, the UE may transmit an uplink transmission with a transmission power based on the open loop power value in the one or more open loop power control parameter sets. For example, 910 may be performed by application processor(s) 1106, cellular baseband processor(s) 1124, transceiver(s) 1122, antenna(s) 1180, and/or duplex-mode-dependent OLPC component 198 of FIG. 11. In some aspects, the open loop power value may be determined by the UE based on the indication received at 908. Referring to FIG. 5, for example, the UE 504 may transmit the UL transmission 514.

In some aspects, the indication received at 908 may include a set of bits in an open loop control parameter set indication field and the one or more open loop power control parameter sets configured in association with the configuration received at 902 may include two open loop power control parameter sets. In some aspects, the set of bits may include at least one bit included in the indication that indicates one open loop power control parameter set of the two open loop power control parameter sets to use to determine the open loop power value and at least one set of one or more bits indicating the open loop power value within the one open loop power control parameter set indicated by the at least one bit. For example, referring to FIG. 7, the configuration received at 902 may include a configuration of a first open loop power control parameter set (e.g., P0-PUSCH-Set-r16 751) and a second open loop power control parameter set (e.g., P0-PUSCH-Set-r16 761). The indication received at 908, in some aspects, may include one of the set of updated indications 720.

The configuration received at 902, in some aspects, may include two or more open loop power values, and the one or more open loop power control parameter sets may include one open loop power control parameter set including a first open loop power value associated with a half-duplex mode and a second open loop power value associated with a full-duplex mode. The indication received at 908, in some aspects, may include one of a first indication of the half-duplex mode or a second indication of the full-duplex mode associated with a slot including the uplink transmission, and transmitting the uplink transmission at 910 may include one of transmitting the uplink transmission with the transmission power based on the first open loop power value for the uplink transmission as indicated by the first indication or transmitting the uplink transmission with the transmission power based on the second open loop power value for the uplink transmission as indicated by the second indication.

The configuration received at 902, in some aspects, may include four open loop power values and the one or more open loop power control parameter sets may include one open loop power control parameter set including a first pair of open loop power values associated with a half-duplex mode and a second pair of open loop power values associated with a full-duplex mode. The indication of the open loop power value received at 908 may include one of a first indication of the half-duplex mode or a second indication of the full-duplex mode associated with a slot including the uplink transmission, and transmitting the uplink transmission at 910 may include one of transmitting the uplink transmission with the transmission power based on one open loop power value of the first pair of open loop power values as indicated by the first indication or transmitting the uplink transmission with the transmission power based on one open loop power value of the second pair of open loop power values as indicated by the second indication.

The configuration received at 902, in some aspects, may include four open loop power values and the one or more open loop power control parameter sets may include one open loop power control parameter set including a first list of open loop power values associated with a half-duplex mode and a second list of open loop power values associated with a full-duplex mode. The indication of the open loop power value received at 908 may include one of a first indication of a half-duplex mode or a second indication of a full-duplex mode associated with a slot including the uplink transmission. In some aspects, transmitting the uplink transmission at 910 may include one of transmitting the uplink transmission with the transmission power based on one open loop power value of the first list of open loop power values for the uplink transmission as indicated by the first indication or transmitting the uplink transmission with the transmission power based on one open loop power value of the second list of open loop power values for the uplink transmission as indicated by the second indication.

The configuration received at 902, in some aspects, may include four open loop power values and the one or more open loop power control parameter sets may include two open loop power control parameter sets including a first open loop power control parameter set configured for a first TRP of a network device associated with the uplink transmission and a second open loop power control parameter set configured for a second TRP of the network device. In some aspects, the first open loop power control parameter set may be associated with a half-duplex mode of the first TRP and the second open loop power control parameter set may be associated with a full-duplex mode of the first TRP. In some aspects, the activation indication may be received at 904 based on the configuration received at 902. Based on the configuration received at 902 and the activation indication received at 904, the UE may, at 906, associate the first open loop power control parameter set with the half-duplex mode of the first TRP and the second open loop power control parameter set with the full-duplex mode of the first TRP. The indication of the open loop power value received at 908, in some aspects, may include one of a first indication of the half-duplex mode or a second indication of the full-duplex mode associated with a slot including the uplink transmission. Transmitting the uplink transmission at 910, in some aspects, may include one of transmitting the uplink transmission with the transmission power based on one open loop power value of the first open loop power control parameter set for the uplink transmission as indicated by the first indication or transmitting the uplink transmission with the transmission power based on one open loop power value of the second open loop power control parameter set for the uplink transmission as indicated by the second indication.

The configuration received at 902, in some aspects, may include two open loop power control parameter sets including a first open loop power control parameter set associated with a first duplex mode and including a first open loop power value of the two or more open loop power values and an additional parameter value used for open loop power control and a second open loop power control parameter set associated with a second duplex mode and including at least one additional open loop power value of the two or more open loop power values. The indication of the open loop power value received at 908, in some aspects, may include one of a first indication of the first duplex mode or a second indication of the second duplex mode associated with a slot including the uplink transmission. In some aspects, receiving the indication at 908 may include receiving the first indication via DCI associated at the UE with the first duplex mode and the DCI includes one of the first indication omitting the one or more bits associated with the indication that are configured to indicate an open loop power value in the second open loop power control parameter set or the first indication with a known value of the one or more bits associated with the indication that are configured to indicate an open loop power value in the second open loop power control parameter set. In some aspects, transmitting the uplink transmission at 910 may include one of transmitting the uplink transmission with the transmission power based on the first open loop power value of the first open loop power control parameter set for the uplink transmission as indicated by the first indication, where determining to use the first open loop power value comprises ignoring one or more bits associated with the indication that are configured to indicate an open loop power value in the second open loop power control parameter set or transmitting the uplink transmission with the transmission power based on one open loop power value of the at least one additional open loop power value for the uplink transmission as indicated by the second indication.

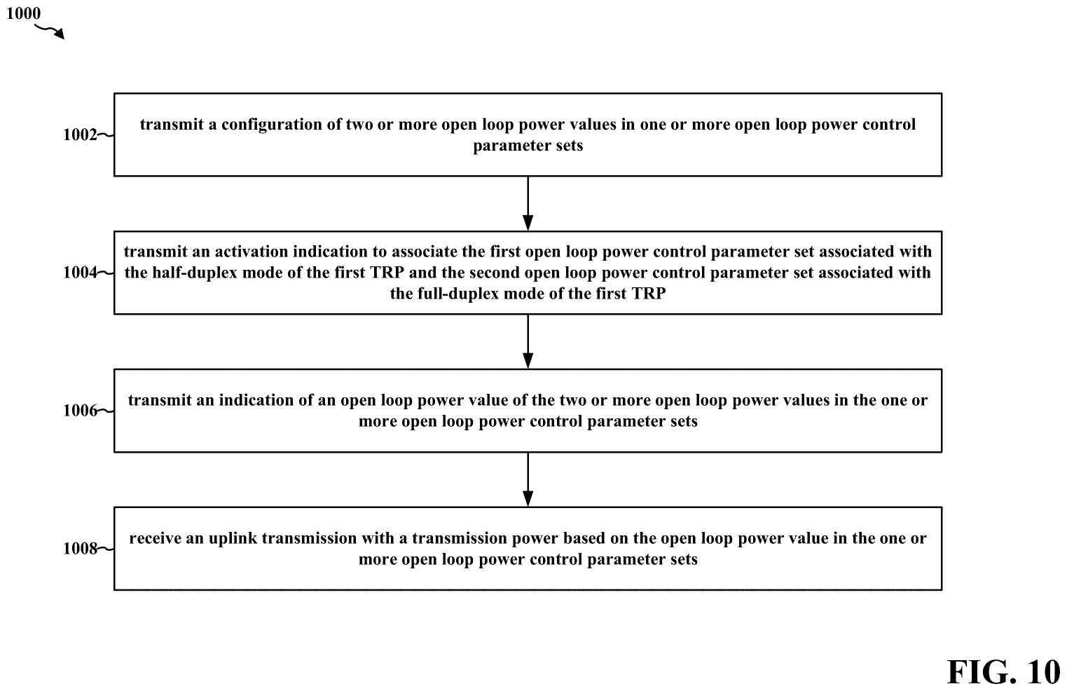

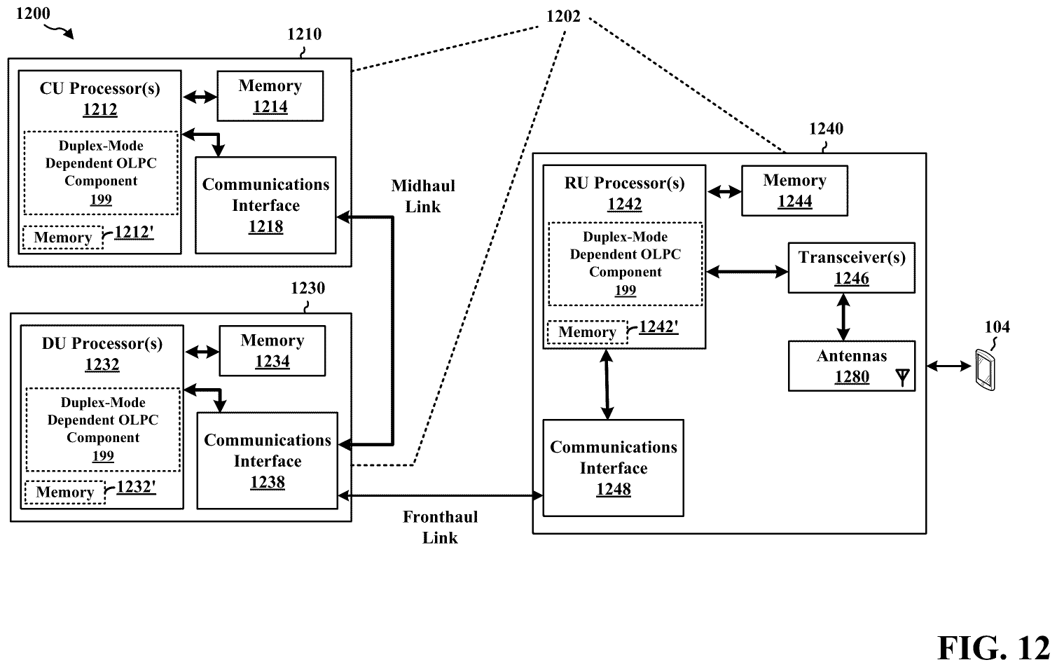

FIG. 10 is a flowchart 1000 of a method of wireless communication. The method may be performed by a base station (e.g., the base station 102, 502; the network entity 1102, 1202). At 1002, the base station may transmit a configuration of two or more open loop power values in one or more open loop power control parameter sets. In some aspects, each open loop power value of the two or more open loop power values may be associated with a different duplex mode. For example, 1002 may be performed by CU processor(s) 1212, DU processor(s) 1232, RU processor(s) 1242, transceiver(s) 1246, antenna(s) 1280, and/or duplex-mode-dependent OLPC component 199 of FIG. 12. For example, referring to FIG. 5, the base station 502 may transmit open loop power control parameter configuration 506.

At 1004, the base station may transmit an activation indication to associate a first open loop power control parameter set with a half-duplex mode of the first TRP and a second open loop power control parameter set with the full-duplex mode of the first TRP. In some aspects, the activation may be transmitted via at least one of an RRC configuration, a MAC-CE, or DCI. For example, 1004 may be performed by CU processor(s) 1212, DU processor(s) 1232, RU processor(s) 1242, transceiver(s) 1246, antenna(s) 1280, and/or duplex-mode-dependent OLPC component 199 of FIG. 12. The activation indication, in some aspects, may further indicate one of a time for reverting to associating the first open loop power control parameter set with a first TRP and the second open loop power control parameter set with a second TRP. In some aspects, the time for reverting to associating the first open loop power control parameter set with the first TRP and the second open loop power control parameter set with the second TRP may be indicated to be based on one or more of a known time, a duration, or receiving a deactivation indication. For example, referring to FIG. 5, the base station 502 may transmit duplex-mode-dependent OLPC configuration indication 508.

In some aspects, the UE may associate the first open loop power control parameter set with the half-duplex mode of the first TRP and the second open loop power control parameter set with the full-duplex mode of the first TRP. Referring to FIG. 5, for example, the UE 504 may, at 509, associate the first and second open loop power control parameter set lists with the first duplex mode of the first TRP and the second duplex mode of the first TRP, respectively.

At 1006, the base station may transmit an indication of an open loop power value of the two or more open loop power values in the one or more open loop power control parameter sets. For example, 1006 may be performed by CU processor(s) 1212, DU processor(s) 1232, RU processor(s) 1242, transceiver(s) 1246, antenna(s) 1280, and/or duplex-mode-dependent OLPC component 199 of FIG. 12. In some aspects, the indication may include a set of bits in an open loop control parameter set indication field. The indication, in some aspects, may be an indication of a duplex mode. For example, referring to FIG. 5, the base station 502 may transmit OLPC parameter indication 510.

At 1008, the base station may receive an uplink transmission with a transmission power based on the open loop power value in the one or more open loop power control parameter sets. For example, 1008 may be performed by CU processor(s) 1212, DU processor(s) 1232, RU processor(s) 1242, transceiver(s) 1246, antenna(s) 1280, and/or duplex-mode-dependent OLPC component 199 of FIG. 12. In some aspects, the open loop power value may be determined by the UE based on the indication transmitted at 1006. Referring to FIG. 5, for example, the base station 502 may receive the UL transmission 514.

FIG. 11 is a diagram 1100 illustrating an example of a hardware implementation for an apparatus 1104. The apparatus 1104 may be a UE, a component of a UE, or may implement UE functionality. In some aspects, the apparatus 1104 may include at least one cellular baseband processor 1124 (also referred to as a modem) coupled to one or more transceivers 1122 (e.g., cellular RF transceiver). The cellular baseband processor(s) 1124 may include at least one on-chip memory 1124′. In some aspects, the apparatus 1104 may further include one or more subscriber identity modules (SIM) cards 1120 and at least one application processor 1106 coupled to a secure digital (SD) card 1108 and a screen 1110. The application processor(s) 1106 may include on-chip memory 1106′. In some aspects, the apparatus 1104 may further include a Bluetooth module 1112, a WLAN module 1114, an SPS module 1116 (e.g., GNSS module), one or more sensor modules 1118 (e.g., barometric pressure sensor/altimeter; motion sensor such as inertial measurement unit (IMU), gyroscope, and/or accelerometer(s); light detection and ranging (LIDAR), radio assisted detection and ranging (RADAR), sound navigation and ranging (SONAR), magnetometer, audio and/or other technologies used for positioning), additional memory modules 1126, a power supply 1130, and/or a camera 1132. The Bluetooth module 1112, the WLAN module 1114, and the SPS module 1116 may include an on-chip transceiver (TRX) (or in some cases, just a receiver (RX)). The Bluetooth module 1112, the WLAN module 1114, and the SPS module 1116 may include their own dedicated antennas and/or utilize one or more antennas 1180 for communication. The cellular baseband processor(s) 1124 communicates through the transceiver(s) 1122 via the one or more antennas 1180 with the UE 104 and/or with an RU associated with a network entity 1102. The cellular baseband processor(s) 1124 and the application processor(s) 1106 may each include a computer-readable medium/memory 1124′, 1106′, respectively. The additional memory modules 1126 may also be considered a computer-readable medium/memory. Each computer-readable medium/memory 1124′, 1106′, 1126 may be non-transitory. The cellular baseband processor(s) 1124 and the application processor(s) 1106 are each responsible for general processing, including the execution of software stored on the computer-readable medium/memory. The software, when executed by the cellular baseband processor(s) 1124/application processor(s) 1106, causes the cellular baseband processor(s) 1124/application processor(s) 1106 to perform the various functions described supra. The computer-readable medium/memory may also be used for storing data that is manipulated by the cellular baseband processor(s) 1124/application processor(s) 1106 when executing software. The cellular baseband processor(s) 1124/application processor(s) 1106 may be a component of the UE 350 and may include the at least one memory 360 and/or at least one of the TX processor 368, the RX processor 356, and the controller/processor 359. In one configuration, the apparatus 1104 may be at least one processor chip (modem and/or application) and include just the cellular baseband processor(s) 1124 and/or the application processor(s) 1106, and in another configuration, the apparatus 1104 may be the entire UE (e.g., see UE 350 of FIG. 3) and include the additional modules of the apparatus 1104.

As discussed supra, the duplex-mode-dependent OLPC component 198 may be configured to receive a configuration of two or more open loop power values in one or more open loop power control parameter sets, each open loop power value of the two or more open loop power values associated with a different duplex mode. The duplex-mode-dependent OLPC component 198 may also be configured to receive an indication of an open loop power value of the two or more open loop power values in the one or more open loop power control parameter sets and transmit an uplink transmission with a transmission power based on the open loop power value in the one or more open loop power control parameter sets. The duplex-mode-dependent OLPC component 198 or another component of the apparatus 1104 may be configured to perform any of the aspects described in connection with the flowcharts in FIG. 8 or 9, and/or performed by the UE in the communication flow of FIG. 5. The duplex-mode-dependent OLPC component 198 may be within the cellular baseband processor(s) 1124, the application processor(s) 1106, or both the cellular baseband processor(s) 1124 and the application processor(s) 1106. The duplex-mode-dependent OLPC component 198 may be one or more hardware components specifically configured to carry out the stated processes/algorithm, implemented by one or more processors configured to perform the stated processes/algorithm, stored within a computer-readable medium for implementation by one or more processors, or some combination thereof. When multiple processors are implemented, the multiple processors may perform the stated processes/algorithm individually or in combination. As shown, the apparatus 1104 may include a variety of components configured for various functions. In one configuration, the apparatus 1104, and in particular the cellular baseband processor(s) 1124 and/or the application processor(s) 1106, may include means for receiving a configuration of two or more open loop power values in one or more open loop power control parameter sets. The apparatus 1104, and in particular the cellular baseband processor(s) 1124 and/or the application processor(s) 1106, may include means for receiving an indication of an open loop power value of the two or more open loop power values in the one or more open loop power control parameter sets. The apparatus 1104, and in particular the cellular baseband processor(s) 1124 and/or the application processor(s) 1106, may include means for transmitting an uplink transmission with a transmission power based on the open loop power value in the one or more open loop power control parameter sets. The apparatus 1104, and in particular the cellular baseband processor(s) 1124 and/or the application processor(s) 1106, may include means for receiving an activation indication to associate the first open loop power control parameter set with the half-duplex mode of the first TRP and the second open loop power control parameter set with the full-duplex mode of the first TRP. The apparatus 1104, and in particular the cellular baseband processor(s) 1124 and/or the application processor(s) 1106, may include means for associating the first open loop power control parameter set with the half-duplex mode of the first TRP and the second open loop power control parameter set with the full-duplex mode of the first TRP. The apparatus 1104 may further include means for performing any of the aspects described in connection with the flowcharts in FIG. 8 or 9, and/or performed by the UE in the communication flow of FIG. 5. The means may be the duplex-mode-dependent OLPC component 198 of the apparatus 1104 configured to perform the functions recited by the means. As described supra, the apparatus 1104 may include the TX processor 368, the RX processor 356, and the controller/processor 359. As such, in one configuration, the means may be the TX processor 368, the RX processor 356, and/or the controller/processor 359 configured to perform the functions recited by the means or as described in relation to FIGS. 8 and 9.

FIG. 12 is a diagram 1200 illustrating an example of a hardware implementation for a network entity 1202. The network entity 1202 may be a BS, a component of a BS, or may implement BS functionality. The network entity 1202 may include at least one of a CU 1210, a DU 1230, or an RU 1240. For example, depending on the layer functionality handled by the duplex-mode-dependent OLPC component 199, the network entity 1202 may include the CU 1210; both the CU 1210 and the DU 1230; each of the CU 1210, the DU 1230, and the RU 1240; the DU 1230; both the DU 1230 and the RU 1240; or the RU 1240. The CU 1210 may include at least one CU processor 1212. The CU processor(s) 1212 may include on-chip memory 1212′. In some aspects, the CU 1210 may further include additional memory modules 1214 and a communications interface 1218. The CU 1210 communicates with the DU 1230 through a midhaul link, such as an F1 interface. The DU 1230 may include at least one DU processor 1232. The DU processor(s) 1232 may include on-chip memory 1232′. In some aspects, the DU 1230 may further include additional memory modules 1234 and a communications interface 1238. The DU 1230 communicates with the RU 1240 through a fronthaul link. The RU 1240 may include at least one RU processor 1242. The RU processor(s) 1242 may include on-chip memory 1242′. In some aspects, the RU 1240 may further include additional memory modules 1244, one or more transceivers 1246, one or more antennas 1280, and a communications interface 1248. The RU 1240 communicates with the UE 104. The on-chip memory 1212′, 1232′, 1242′ and the additional memory modules 1214, 1234, 1244 may each be considered a computer-readable medium/memory. Each computer-readable medium/memory may be non-transitory. Each of the processors 1212, 1232, 1242 is responsible for general processing, including the execution of software stored on the computer-readable medium/memory. The software, when executed by the corresponding processor(s) causes the processor(s) to perform the various functions described supra. The computer-readable medium/memory may also be used for storing data that is manipulated by the processor(s) when executing software.

As discussed supra, the duplex-mode-dependent OLPC component 199 may be configured to output a configuration of two or more open loop power values in one or more open loop power control parameter sets, each open loop power value of the two or more open loop power values associated with a different duplex mode. The duplex-mode-dependent OLPC component 199 may also be configured to transmit an indication of an open loop power value of the two or more open loop power values in the one or more open loop power control parameter sets and receive an uplink transmission with a transmission power based on the open loop power value in the one or more open loop power control parameter sets. The duplex-mode-dependent OLPC component 199, or another component of the network entity 1202, may be further configured to perform any of the aspects described in connection with the flowchart in FIG. 10, and/or performed by the base station in the communication flow of FIG. 5. The duplex-mode-dependent OLPC component 199 may be within one or more processors of one or more of the CU 1210, DU 1230, and the RU 1240. The duplex-mode-dependent OLPC component 199 may be one or more hardware components specifically configured to carry out the stated processes/algorithm, implemented by one or more processors configured to perform the stated processes/algorithm, stored within a computer-readable medium for implementation by one or more processors, or some combination thereof. When multiple processors are implemented, the multiple processors may perform the stated processes/algorithm individually or in combination. The network entity 1202 may include a variety of components configured for various functions. In one configuration, the network entity 1202 may include means for transmitting a configuration of two or more open loop power values in one or more open loop power control parameter sets. The network entity 1202 may include means for transmitting an indication of an open loop power value of the two or more open loop power values in the one or more open loop power control parameter sets. The network entity 1202 may include means for receiving an uplink transmission with a transmission power based on the open loop power value in the one or more open loop power control parameter sets. The network entity 1202 may include means for transmitting an activation indication to associate a first open loop power control parameter set with a half-duplex mode of the first TRP and a second open loop power control parameter set with the full-duplex mode of the first TRP. The network entity 1202 may further include means for performing any of the aspects described in connection with the flowchart in FIG. 10, and/or performed by the base station in the communication flow of FIG. 5. The means may be the duplex-mode-dependent OLPC component 199 of the network entity 1202 configured to perform the functions recited by the means. As described supra, the network entity 1202 may include the TX processor 316, the RX processor 370, and the controller/processor 375. As such, in one configuration, the means may be the TX processor 316, the RX processor 370, and/or the controller/processor 375 configured to perform the functions recited by the means or as described in relation to FIG. 10.

Various aspects relate generally to enabling the network to signal open loop power control parameters (e.g., values for P0) differently, e.g., based on a mode of operation such as a duplex mode (e.g., full-duplex, or half-duplex). In some aspects, a DCI may include more bits to facilitate more advanced open loop power control for a flexible duplex implementation. Some aspects more specifically relate to configuring two or more open loop power control parameters (or open loop power values) associated with different modes of operation. In some examples, a wireless device may be configured to receive a configuration of two or more open loop power values in one or more open loop power control parameter sets, each open loop power value of the two or more open loop power values associated with a different duplex mode. The wireless device may also be configured to receive an indication of an open loop power value of the two or more open loop power values in the one or more open loop power control parameter sets and transmit an uplink transmission with a transmission power based on the open loop power value in the one or more open loop power control parameter sets.

Particular aspects of the subject matter described in this disclosure can be implemented to realize one or more of the following potential advantages. In some examples, by configuring two or more open loop power control parameters (or open loop power values) associated with different modes of operation, the described techniques can be used to a transmission power dynamically for different modes of operation and/or using a larger number of candidate transmission powers (e.g., open loop power values or power control parameters) to more accurately match a desired power.

It is understood that the specific order or hierarchy of blocks in the processes/flowcharts disclosed is an illustration of example approaches. Based upon design preferences, it is understood that the specific order or hierarchy of blocks in the processes/flowcharts may be rearranged. Further, some blocks may be combined or omitted. The accompanying method claims present elements of the various blocks in a sample order, and are not limited to the specific order or hierarchy presented.

The previous description is provided to enable any person skilled in the art to practice the various aspects described herein. Various modifications to these aspects will be readily apparent to those skilled in the art, and the generic principles defined herein may be applied to other aspects. Thus, the claims are not limited to the aspects described herein, but are to be accorded the full scope consistent with the language claims. Reference to an element in the singular does not mean “one and only one” unless specifically so stated, but rather “one or more.” Terms such as “if,” “when,” and “while” do not imply an immediate temporal relationship or reaction. That is, these phrases, e.g., “when,” do not imply an immediate action in response to or during the occurrence of an action, but simply imply that if a condition is met then an action will occur, but without requiring a specific or immediate time constraint for the action to occur. The word “exemplary” is used herein to mean “serving as an example, instance, or illustration.” Any aspect described herein as “exemplary” is not necessarily to be construed as preferred or advantageous over other aspects. Unless specifically stated otherwise, the term “some” refers to one or more. Combinations such as “at least one of A, B, or C,” “one or more of A, B, or C,” “at least one of A, B, and C,” “one or more of A, B, and C,” and “A, B, C, or any combination thereof” include any combination of A, B, and/or C, and may include multiples of A, multiples of B, or multiples of C. Specifically, combinations such as “at least one of A, B, or C,” “one or more of A, B, or C,” “at least one of A, B, and C,” “one or more of A, B, and C,” and “A, B, C, or any combination thereof” may be A only, B only, C only, A and B, A and C, B and C, or A and B and C, where any such combinations may contain one or more member or members of A, B, or C. Sets should be interpreted as a set of elements where the elements number one or more. Accordingly, for a set of X, X would include one or more elements. When at least one processor is configured to perform a set of functions, the at least one processor, individually or in any combination, is configured to perform the set of functions. Accordingly, each processor of the at least one processor may be configured to perform a particular subset of the set of functions, where the subset is the full set, a proper subset of the set, or an empty subset of the set. A processor may be referred to as processor circuitry. A memory/memory module may be referred to as memory circuitry. If a first apparatus receives data from or transmits data to a second apparatus, the data may be received/transmitted directly between the first and second apparatuses, or indirectly between the first and second apparatuses through a set of apparatuses. A device configured to “output” data, such as a transmission, signal, or message, may transmit the data, for example with a transceiver, or may send the data to a device that transmits the data. A device configured to “obtain” data, such as a transmission, signal, or message, may receive, for example with a transceiver, or may obtain the data from a device that receives the data. Information stored in a memory includes instructions and/or data. All structural and functional equivalents to the elements of the various aspects described throughout this disclosure that are known or later come to be known to those of ordinary skill in the art are expressly incorporated herein by reference and are encompassed by the claims. Moreover, nothing disclosed herein is dedicated to the public regardless of whether such disclosure is explicitly recited in the claims. The words “module,” “mechanism,” “element,” “device,” and the like may not be a substitute for the word “means.” As such, no claim element is to be construed as a means plus function unless the element is expressly recited using the phrase “means for.”

As used herein, the phrase “based on” shall not be construed as a reference to a closed set of information, one or more conditions, one or more factors, or the like. In other words, the phrase “based on A” (where “A” may be information, a condition, a factor, or the like) shall be construed as “based at least on A” unless specifically recited differently.

The following aspects are illustrative only and may be combined with other aspects or teachings described herein, without limitation.

Aspect 1 is a method of wireless communication at a wireless device, comprising: receiving a configuration of two or more open loop power values in one or more open loop power control parameter sets, each open loop power value of the two or more open loop power values associated with a different duplex mode; receiving an indication of an open loop power value of the two or more open loop power values in the one or more open loop power control parameter sets; and transmitting an uplink transmission with a transmission power based on the open loop power value in the one or more open loop power control parameter sets.

Aspect 2 is the method of aspect 1, wherein the indication comprises a set of bits in an open loop control parameter set indication field and wherein the one or more open loop power control parameter sets comprise two open loop power control parameter sets, wherein the set of bits includes at least one bit included in the indication that indicates one open loop power control parameter set of the two open loop power control parameter sets to use to determine the open loop power value and at least one set of one or more bits indicating the open loop power value within the one open loop power control parameter set indicated by the at least one bit.

Aspect 3 is the method of aspect 1, wherein the indication is included in downlink control information and comprises one of a first indication of a first open loop power control parameter set of the one or more open loop power control parameter sets indicating the open loop power value to use for the uplink transmission or a second indication of a duplex mode associated with the first open loop power control parameter set of the one or more open loop power control parameter sets indicating the open loop power value to use for the uplink transmission.

Aspect 4 is the method of aspect 1, wherein the two or more open loop power values comprise two open loop power values, the one or more open loop power control parameter sets comprise one open loop power control parameter set including a first open loop power value associated with a half-duplex mode and a second open loop power value associated with a full-duplex mode, and the indication of the open loop power value comprises one of a first indication of the half-duplex mode or a second indication of the full-duplex mode associated with a slot including the uplink transmission, wherein transmitting the uplink transmission further comprises one of: transmitting the uplink transmission with the transmission power based on the first open loop power value for the uplink transmission as indicated by the first indication; or transmitting the uplink transmission with the transmission power based on the second open loop power value for the uplink transmission as indicated by the second indication.

Aspect 5 is the method of aspect 1, wherein the two or more open loop power values comprise four open loop power values, the one or more open loop power control parameter sets comprise one open loop power control parameter set including a first pair of open loop power values associated with a half-duplex mode and a second pair of open loop power values associated with a full-duplex mode, and the indication of the open loop power value comprises one of a first indication of the half-duplex mode or a second indication of the full-duplex mode associated with a slot including the uplink transmission, wherein transmitting the uplink transmission further comprises one of: transmitting the uplink transmission with the transmission power based on one open loop power value of the first pair of open loop power values as indicated by the first indication; or transmitting the uplink transmission with the transmission power based on one open loop power value of the second pair of open loop power values as indicated by the second indication.

Aspect 6 is the method of aspect 1, wherein the two or more open loop power values comprise four open loop power values, the one or more open loop power control parameter sets comprise one open loop power control parameter set including a first list of open loop power values associated with a half-duplex mode and a second list of open loop power values associated with a full-duplex mode, and the indication of the open loop power value comprises one of a first indication of a half-duplex mode or a second indication of a full-duplex mode associated with a slot including the uplink transmission, wherein transmitting the uplink transmission further comprises one of: transmitting the uplink transmission with the transmission power based on one open loop power value of the first list of open loop power values for the uplink transmission as indicated by the first indication; or transmitting the uplink transmission with the transmission power based on one open loop power value of the second list of open loop power values for the uplink transmission as indicated by the second indication.

Aspect 7 is the method of aspect 1, wherein the two or more open loop power values comprise four open loop power values, the one or more open loop power control parameter sets comprise two open loop power control parameter sets including a first open loop power control parameter set configured for a first transmission reception point (TRP) of a network device associated with the uplink transmission and a second open loop power control parameter set configured for a second TRP of the network device, the first open loop power control parameter set associated with a half-duplex mode of the first TRP and the second open loop power control parameter set associated with a full-duplex mode of the first TRP, and the indication of the open loop power value comprises one of a first indication of the half-duplex mode or a second indication of the full-duplex mode associated with a slot including the uplink transmission, wherein transmitting the uplink transmission further comprises one of: transmitting the uplink transmission with the transmission power based on one open loop power value of the first open loop power control parameter set for the uplink transmission as indicated by the first indication; or transmitting the uplink transmission with the transmission power based on one open loop power value of the second open loop power control parameter set for the uplink transmission as indicated by the second indication.

Aspect 8 is the method of aspect 7, further comprising: receiving an activation indication to associate the first open loop power control parameter set with the half-duplex mode of the first TRP and the second open loop power control parameter set with the full-duplex mode of the first TRP; and associating the first open loop power control parameter set with the half-duplex mode of the first TRP and the second open loop power control parameter set with the full-duplex mode of the first TRP.

Aspect 9 is the method of aspect 8, wherein receiving the activation indication comprises receiving the activation indication via at least one of a radio resource control (RRC) configuration, a media access control (MAC) control element (CE) (MAC-CE), or downlink control information (DCI), and the activation indication further indicates one of a time for reverting to associating the first open loop power control parameter set with the first TRP and the second open loop power control parameter set with the second TRP.

Aspect 10 is the method of aspect 9, wherein the time for reverting to associating the first open loop power control parameter set with the first TRP and the second open loop power control parameter set with the second TRP is indicated to be based on one or more of a known time, a duration, or receiving a deactivation indication.

Aspect 11 is the method of aspect 1, wherein the one or more open loop power control parameter sets comprise two open loop power control parameter sets including a first open loop power control parameter set associated with a first duplex mode and including a first open loop power value of the two or more open loop power values and an additional parameter value used for open loop power control and a second open loop power control parameter set associated with a second duplex mode and including at least one additional open loop power value of the two or more open loop power values, and the indication of the open loop power value comprises one of a first indication of the first duplex mode or a second indication of the second duplex mode associated with a slot including the uplink transmission, wherein transmitting the uplink transmission further comprises one of: transmitting the uplink transmission with the transmission power based on the first open loop power value of the first open loop power control parameter set for the uplink transmission as indicated by the first indication, wherein determining to use the first open loop power value comprises ignoring one or more bits associated with the indication that are configured to indicate an open loop power value in the second open loop power control parameter set; or transmitting the uplink transmission with the transmission power based on one open loop power value of the at least one additional open loop power value for the uplink transmission as indicated by the second indication.

Aspect 12 is the method of aspect 11, wherein receiving the indication comprises receiving the first indication via downlink control information (DCI) associated at the wireless device with the first duplex mode and the DCI comprises one of the first indication omitting the one or more bits associated with the indication that are configured to indicate an open loop power value in the second open loop power control parameter set or the first indication with a known value of the one or more bits associated with the indication that are configured to indicate an open loop power value in the second open loop power control parameter set.

Aspect 13 is a method of wireless communication at a network device, comprising: transmitting a configuration of two or more open loop power values in one or more open loop power control parameter sets, each open loop power value of the two or more open loop power values associated with a different duplex mode; transmitting an indication of an open loop power value of the two or more open loop power values in the one or more open loop power control parameter sets; and receiving an uplink transmission with a transmission power based on the open loop power value in the one or more open loop power control parameter sets.

Aspect 14 is the method of aspect 13, wherein the indication comprises a set of bits in an open loop control parameter set indication field and wherein the one or more open loop power control parameter sets comprise two open loop power control parameter sets, wherein the set of bits includes at least one bit included in the indication that indicates one open loop power control parameter set of the two open loop power control parameter sets to use to determine the open loop power value and at least one set of one or more bits indicating the open loop power value within the one open loop power control parameter set indicated by the at least one bit.

Aspect 15 is the method of aspect 13, wherein the indication is included in downlink control information and comprises one of a first indication of a first open loop power control parameter set of the one or more open loop power control parameter sets indicating the open loop power value to use for the uplink transmission or a second indication of a duplex mode associated with the first open loop power control parameter set of the one or more open loop power control parameter sets indicating the open loop power value to use for the uplink transmission.

Aspect 16 is the method of aspect 13, wherein the two or more open loop power values comprise two open loop power values, the one or more open loop power control parameter sets comprise one open loop power control parameter set including a first open loop power value associated with a half-duplex mode and a second open loop power value associated with a full-duplex mode, and the indication of the open loop power value comprises one of a first indication of the half-duplex mode or a second indication of the full-duplex mode associated with a slot including the uplink transmission, wherein receiving the uplink transmission further comprises one of: receiving the uplink transmission with the transmission power based on the first open loop power value for the uplink transmission as indicated by the first indication; or receiving the uplink transmission with the transmission power based on the second open loop power value for the uplink transmission as indicated by the second indication.

Aspect 17 is the method of aspect 13, wherein the two or more open loop power values comprise four open loop power values, the one or more open loop power control parameter sets comprise one open loop power control parameter set including a first pair of open loop power values associated with a half-duplex mode and a second pair of open loop power values associated with a full-duplex mode, and the indication of the open loop power value comprises one of a first indication of the half-duplex mode or a second indication of the full-duplex mode associated with a slot including the uplink transmission, wherein receiving the uplink transmission further comprises one of: receiving the uplink transmission with the transmission power based on one open loop power value of the first pair of open loop power values as indicated by the first indication; or receiving the uplink transmission with the transmission power based on one open loop power value of the second pair of open loop power values as indicated by the second indication.

Aspect 18 is the method of aspect 13, wherein the two or more open loop power values comprise four open loop power values, the one or more open loop power control parameter sets comprise one open loop power control parameter set including a first list of open loop power values associated with a half-duplex mode and a second list of open loop power values associated with a full-duplex mode, and the indication of the open loop power value comprises one of a first indication of a half-duplex mode or a second indication of a full-duplex mode associated with a slot including the uplink transmission, wherein receiving the uplink transmission further comprises one of: receiving the uplink transmission with the transmission power based on one open loop power value of the first list of open loop power values for the uplink transmission as indicated by the first indication; or receiving the uplink transmission with the transmission power based on one open loop power value of the second list of open loop power values for the uplink transmission as indicated by the second indication.

Aspect 19 is the method of aspect 13, wherein the two or more open loop power values comprise four open loop power values, the one or more open loop power control parameter sets comprise two open loop power control parameter sets including a first open loop power control parameter set configured for a first transmission reception point (TRP) of a network device associated with the uplink transmission and a second open loop power control parameter set configured for a second TRP of the network device, the first open loop power control parameter set associated with a half-duplex mode of the first TRP and the second open loop power control parameter set associated with a full-duplex mode of the first TRP, and the indication of the open loop power value comprises one of a first indication of the half-duplex mode or a second indication of the full-duplex mode associated with a slot including the uplink transmission, wherein receiving the uplink transmission further comprises one of: receiving the uplink transmission with the transmission power based on one open loop power value of the first open loop power control parameter set for the uplink transmission as indicated by the first indication; or receiving the uplink transmission with the transmission power based on one open loop power value of the second open loop power control parameter set for the uplink transmission as indicated by the second indication.

Aspect 20 is the method of aspect 19, further comprising: transmitting an activation indication to associate the first open loop power control parameter set with the half-duplex mode of the first TRP and the second open loop power control parameter set with the full-duplex mode of the first TRP; and wherein the wireless device associates the first open loop power control parameter set with the half-duplex mode of the first TRP and the second open loop power control parameter set with the full-duplex mode of the first TRP.

Aspect 21 is the method of aspect 20, wherein transmitting the activation indication comprises receiving the activation indication via at least one of a radio resource control (RRC) configuration, a media access control (MAC) control element (CE) (MAC-CE), or downlink control information (DCI), and the activation indication further indicates one of a time for reverting to associating the first open loop power control parameter set with the first TRP and the second open loop power control parameter set with the second TRP.

Aspect 22 is the method of aspect 21, wherein the time for reverting to associating the first open loop power control parameter set with the first TRP and the second open loop power control parameter set with the second TRP is indicated to be based on one or more of a known time, a duration, or receiving a deactivation indication.

Aspect 23 is the method of aspect 13, wherein the one or more open loop power control parameter sets comprise two open loop power control parameter sets including a first open loop power control parameter set associated with a first duplex mode and including a first open loop power value of the two or more open loop power values and an additional parameter value used for open loop power control and a second open loop power control parameter set associated with a second duplex mode and including at least one additional open loop power value of the two or more open loop power values, and the indication of the open loop power value comprises one of a first indication of the first duplex mode or a second indication of the second duplex mode associated with a slot including the uplink transmission, wherein receiving the uplink transmission further comprises one of: receiving the uplink transmission with the transmission power based on the first open loop power value of the first open loop power control parameter set for the uplink transmission as indicated by the first indication, wherein determining to use the first open loop power value at the wireless device comprises ignoring one or more bits associated with the indication that are configured to indicate an open loop power value in the second open loop power control parameter set; or receiving the uplink transmission with the transmission power based on one open loop power value of the at least one additional open loop power value for the uplink transmission as indicated by the second indication.

Aspect 24 is the method of aspect 23, wherein receiving the indication comprises receiving the first indication via downlink control information (DCI) associated at the wireless device with the first duplex mode and the DCI comprises one of the first indication omitting the one or more bits associated with the indication that are configured to indicate an open loop power value in the second open loop power control parameter set or the first indication with a known value of the one or more bits associated with the indication that are configured to indicate an open loop power value in the second open loop power control parameter set.

Aspect 25 is an apparatus for wireless communication at a device including a memory and at least one processor coupled to the memory and, based at least in part on information stored in the memory, the at least one processor is configured to implement any of aspects 1 to 12.

Aspect 26 is the apparatus of aspect 25, further including a transceiver or an antenna coupled to the at least one processor.

Aspect 27 is an apparatus for wireless communication at a device including means for implementing any of aspects 1 to 12.

Aspect 28 is a computer-readable medium (e.g., a non-transitory computer-readable medium) storing computer executable code, where the code when executed by a processor causes the processor to implement any of aspects 1 to 12.

Aspect 29 is an apparatus for wireless communication at a device including a memory and at least one processor coupled to the memory and, based at least in part on information stored in the memory, the at least one processor is configured to implement any of aspects 13 to 24.

Aspect 30 is the apparatus of aspect 29, further including a transceiver or an antenna coupled to the at least one processor.

Aspect 31 is an apparatus for wireless communication at a device including means for implementing any of aspects 13 to 24.

Aspect 32 is a computer-readable medium (e.g., a non-transitory computer-readable medium) storing computer executable code, where the code when executed by a processor causes the processor to implement any of aspects 13 to 24.

What is claimed is:

1. An apparatus for wireless communication at a wireless device, comprising:
at least one memory; and
at least one processor coupled to the at least one memory and, based at least in part on stored information that is stored in the at least one memory, the at least one processor, individually or in any combination, is configured to:
receive a configuration of two or more open loop power values in one or more open loop power control parameter sets, each open loop power value of the two or more open loop power values associated with a different duplex mode;
receive an indication of an open loop power value of the two or more open loop power values in the one or more open loop power control parameter sets; and
transmit an uplink transmission with a transmission power based on the open loop power value in the one or more open loop power control parameter sets.

2. The apparatus of claim 1, wherein the indication comprises a set of bits in an open loop control parameter set indication field and wherein the one or more open loop power control parameter sets comprise two open loop power control parameter sets, wherein the set of bits includes at least one bit included in the indication that indicates one open loop power control parameter set of the two open loop power control parameter sets to use to determine the open loop power value and at least one set of one or more bits indicating the open loop power value within the one open loop power control parameter set indicated by the at least one bit.

3. The apparatus of claim 1, wherein the indication is included in downlink control information and comprises one of a first indication of a first open loop power control parameter set of the one or more open loop power control parameter sets indicating the open loop power value to use for the uplink transmission or a second indication of a duplex mode associated with the first open loop power control parameter set of the one or more open loop power control parameter sets indicating the open loop power value to use for the uplink transmission.

4. The apparatus of claim 1, wherein the two or more open loop power values comprise two open loop power values, the one or more open loop power control parameter sets comprise one open loop power control parameter set including a first open loop power value associated with a half-duplex mode and a second open loop power value associated with a full-duplex mode, and the indication of the open loop power value comprises one of a first indication of the half-duplex mode or a second indication of the full-duplex mode associated with a slot including the uplink transmission, wherein to transmit the uplink transmission, the at least one processor, individually or in any combination, is further configured to:
transmit the uplink transmission with the transmission power based on the first open loop power value for the uplink transmission as indicated by the first indication; or
transmit the uplink transmission with the transmission power based on the second open loop power value for the uplink transmission as indicated by the second indication.

5. The apparatus of claim 1, wherein the two or more open loop power values comprise four open loop power values, the one or more open loop power control parameter sets comprise one open loop power control parameter set including a first pair of open loop power values associated with a half-duplex mode and a second pair of open loop power values associated with a full-duplex mode, and the indication of the open loop power value comprises one of a first indication of the half-duplex mode or a second indication of the full-duplex mode associated with a slot including the uplink transmission, wherein to transmit the uplink transmission, the at least one processor, individually or in any combination, is further configured to:
transmit the uplink transmission with the transmission power based on one open loop power value of the first pair of open loop power values as indicated by the first indication; or
transmit the uplink transmission with the transmission power based on one open loop power value of the second pair of open loop power values as indicated by the second indication.

6. The apparatus of claim 1, wherein the two or more open loop power values comprise four open loop power values, the one or more open loop power control parameter sets comprise one open loop power control parameter set including a first list of open loop power values associated with a half-duplex mode and a second list of open loop power values associated with a full-duplex mode, and the indication of the open loop power value comprises one of a first indication of the half-duplex mode or a second indication of the full-duplex mode associated with a slot including the uplink transmission, wherein to transmit the uplink transmission, the at least one processor, individually or in any combination, is further configured to:
transmit the uplink transmission with the transmission power based on one open loop power value of the first list of open loop power values for the uplink transmission as indicated by the first indication; or
transmit the uplink transmission with the transmission power based on one open loop power value of the second list of open loop power values for the uplink transmission as indicated by the second indication.

7. The apparatus of claim 1, wherein the two or more open loop power values comprise four open loop power values, the one or more open loop power control parameter sets comprise two open loop power control parameter sets including a first open loop power control parameter set configured for a first transmission reception point (TRP) of a network device associated with the uplink transmission and a second open loop power control parameter set configured for a second TRP of the network device, the first open loop power control parameter set associated with a half-duplex mode of the first TRP and the second open loop power control parameter set associated with a full-duplex mode of the first TRP, and the indication of the open loop power value comprises one of a first indication of the half-duplex mode or a second indication of the full-duplex mode associated with a slot including the uplink transmission, wherein to transmit the uplink transmission, the at least one processor, individually or in any combination, is further configured to:
transmit the uplink transmission with the transmission power based on one open loop power value of the first open loop power control parameter set for the uplink transmission as indicated by the first indication; or
transmit the uplink transmission with the transmission power based on one open loop power value of the second open loop power control parameter set for the uplink transmission as indicated by the second indication.

8. The apparatus of claim 7, further comprising a transceiver, wherein the at least one processor, individually or in any combination, is further configured to:
receive an activation indication via the transceiver to associate the first open loop power control parameter set with the half-duplex mode of the first TRP and the second open loop power control parameter set with the full-duplex mode of the first TRP; and
associate the first open loop power control parameter set with the half-duplex mode of the first TRP and the second open loop power control parameter set with the full-duplex mode of the first TRP.

9. The apparatus of claim 8, wherein to receive the activation indication the at least one processor, individually or in any combination, is further configured to receive the activation indication via at least one of a radio resource control (RRC) configuration, a media access control (MAC) control element (CE) (MAC-CE), or downlink control information (DCI), and the activation indication further indicates one of a time for reverting to associating the first open loop power control parameter set with the first TRP and the second open loop power control parameter set with the second TRP.

10. The apparatus of claim 9, wherein the time for reverting to associating the first open loop power control parameter set with the first TRP and the second open loop power control parameter set with the second TRP is indicated to be based on one or more of a known time, a duration, or receiving a deactivation indication.

11. The apparatus of claim 1, wherein the one or more open loop power control parameter sets comprise two open loop power control parameter sets including a first open loop power control parameter set associated with a first duplex mode and including a first open loop power value of the two or more open loop power values and an additional parameter value used for open loop power control and a second open loop power control parameter set associated with a second duplex mode and including at least one additional open loop power value of the two or more open loop power values, and the indication of the open loop power value comprises one of a first indication of the first duplex mode or a second indication of the second duplex mode associated with a slot including the uplink transmission, wherein to transmit the uplink transmission, the at least one processor, individually or in any combination, is further configured to:
transmit the uplink transmission with the transmission power based on the first open loop power value of the first open loop power control parameter set for the uplink transmission as indicated by the first indication, wherein the at least one processor, individually or in any combination, is further configured to determine to use the first open loop power value by ignoring one or more bits associated with the indication that are configured to indicate an open loop power value in the second open loop power control parameter set; or
transmit the uplink transmission with the transmission power based on one open loop power value of the at least one additional open loop power value for the uplink transmission as indicated by the second indication.

12. The apparatus of claim 11, wherein to receive the indication the at least one processor, individually or in any combination, is further configured to receive the first indication via downlink control information (DCI) associated at the wireless device with the first duplex mode and the DCI comprises one of the first indication omitting the one or more bits associated with the indication that are configured to indicate the open loop power value in the second open loop power control parameter set or the first indication with a known value of the one or more bits associated with the indication that are configured to indicate the open loop power value in the second open loop power control parameter set.

13. A method of wireless communication at a wireless device, comprising:
receiving a configuration of two or more open loop power values in one or more open loop power control parameter sets, each open loop power value of the two or more open loop power values associated with a different duplex mode;
receiving an indication of an open loop power value of the two or more open loop power values in the one or more open loop power control parameter sets; and
transmitting an uplink transmission with a transmission power based on the open loop power value in the one or more open loop power control parameter sets.

14. The method of claim 13, wherein the indication comprises a set of bits in an open loop control parameter set indication field and wherein the one or more open loop power control parameter sets comprise two open loop power control parameter sets, wherein the set of bits includes at least one bit included in the indication that indicates one open loop power control parameter set of the two open loop power control parameter sets to use to determine the open loop power value and at least one set of one or more bits indicating the open loop power value within the one open loop power control parameter set indicated by the at least one bit.

15. The method of claim 13, wherein the indication is included in downlink control information and comprises one of a first indication of a first open loop power control parameter set of the one or more open loop power control parameter sets indicating the open loop power value to use for the uplink transmission or a second indication of a duplex mode associated with the first open loop power control parameter set of the one or more open loop power control parameter sets indicating the open loop power value to use for the uplink transmission.

16. The method of claim 13, wherein the two or more open loop power values comprise two open loop power values, the one or more open loop power control parameter sets comprise one open loop power control parameter set including a first open loop power value associated with a half-duplex mode and a second open loop power value associated with a full-duplex mode, and the indication of the open loop power value comprises one of a first indication of the half-duplex mode or a second indication of the full-duplex mode associated with a slot including the uplink transmission, wherein transmitting the uplink transmission further comprises one of:
transmitting the uplink transmission with the transmission power based on the first open loop power value for the uplink transmission as indicated by the first indication; or
transmitting the uplink transmission with the transmission power based on the second open loop power value for the uplink transmission as indicated by the second indication.

17. The method of claim 13, wherein the two or more open loop power values comprise four open loop power values, the one or more open loop power control parameter sets comprise one open loop power control parameter set including a first pair of open loop power values associated with a half-duplex mode and a second pair of open loop power values associated with a full-duplex mode, and the indication of the open loop power value comprises one of a first indication of the half-duplex mode or a second indication of the full-duplex mode associated with a slot including the uplink transmission, wherein transmitting the uplink transmission further comprises one of:
transmitting the uplink transmission with the transmission power based on one open loop power value of the first pair of open loop power values as indicated by the first indication; or
transmitting the uplink transmission with the transmission power based on one open loop power value of the second pair of open loop power values as indicated by the second indication.

18. The method of claim 13, wherein the two or more open loop power values comprise four open loop power values, the one or more open loop power control parameter sets comprise one open loop power control parameter set including a first list of open loop power values associated with a half-duplex mode and a second list of open loop power values associated with a full-duplex mode, and the indication of the open loop power value comprises one of a first indication of the half-duplex mode or a second indication of the full-duplex mode associated with a slot including the uplink transmission, wherein transmitting the uplink transmission further comprises one of:
transmitting the uplink transmission with the transmission power based on one open loop power value of the first list of open loop power values for the uplink transmission as indicated by the first indication; or
transmitting the uplink transmission with the transmission power based on one open loop power value of the second list of open loop power values for the uplink transmission as indicated by the second indication.

19. The method of claim 13, wherein the two or more open loop power values comprise four open loop power values, the one or more open loop power control parameter sets comprise two open loop power control parameter sets including a first open loop power control parameter set configured for a first transmission reception point (TRP) of a network device associated with the uplink transmission and a second open loop power control parameter set configured for a second TRP of the network device, the first open loop power control parameter set associated with a half-duplex mode of the first TRP and the second open loop power control parameter set associated with a full-duplex mode of the first TRP, and the indication of the open loop power value comprises one of a first indication of the half-duplex mode or a second indication of the full-duplex mode associated with a slot including the uplink transmission, wherein transmitting the uplink transmission further comprises one of:
transmitting the uplink transmission with the transmission power based on one open loop power value of the first open loop power control parameter set for the uplink transmission as indicated by the first indication; or
transmitting the uplink transmission with the transmission power based on one open loop power value of the second open loop power control parameter set for the uplink transmission as indicated by the second indication.

20. The method of claim 19, further comprising:
receiving an activation indication to associate the first open loop power control parameter set with the half-duplex mode of the first TRP and the second open loop power control parameter set with the full-duplex mode of the first TRP; and
associating the first open loop power control parameter set with the half-duplex mode of the first TRP and the second open loop power control parameter set with the full-duplex mode of the first TRP.

21. The method of claim 20, wherein receiving the activation indication comprises receiving the activation indication via at least one of a radio resource control (RRC) configuration, a media access control (MAC) control element (CE) (MAC-CE), or downlink control information (DCI), and the activation indication further indicates one of a time for reverting to associating the first open loop power control parameter set with the first TRP and the second open loop power control parameter set with the second TRP.

22. The method of claim 21, wherein the time for reverting to associating the first open loop power control parameter set with the first TRP and the second open loop power control parameter set with the second TRP is indicated to be based on one or more of a known time, a duration, or receiving a deactivation indication.

23. The method of claim 13, wherein the one or more open loop power control parameter sets comprise two open loop power control parameter sets including a first open loop power control parameter set associated with a first duplex mode and including a first open loop power value of the two or more open loop power values and an additional parameter value used for open loop power control and a second open loop power control parameter set associated with a second duplex mode and including at least one additional open loop power value of the two or more open loop power values, and the indication of the open loop power value comprises one of a first indication of the first duplex mode or a second indication of the second duplex mode associated with a slot including the uplink transmission, wherein transmitting the uplink transmission further comprises one of:
transmitting the uplink transmission with the transmission power based on the first open loop power value of the first open loop power control parameter set for the uplink transmission as indicated by the first indication, wherein determining to use the first open loop power value comprises ignoring one or more bits associated with the indication that are configured to indicate an open loop power value in the second open loop power control parameter set; or
transmitting the uplink transmission with the transmission power based on one open loop power value of the at least one additional open loop power value for the uplink transmission as indicated by the second indication.

24. The method of claim 23, wherein receiving the indication comprises receiving the first indication via downlink control information (DCI) associated at the wireless device with the first duplex mode and the DCI comprises one of the first indication omitting the one or more bits associated with the indication that are configured to indicate the open loop power value in the second open loop power control parameter set or the first indication with a known value of the one or more bits associated with the indication that are configured to indicate the open loop power value in the second open loop power control parameter set.

25. An apparatus for wireless communication at a wireless device, comprising:
means for receiving a configuration of two or more open loop power values in one or more open loop power control parameter sets, each open loop power value of the two or more open loop power values associated with a different duplex mode;
means for receiving an indication of an open loop power value of the two or more open loop power values in the one or more open loop power control parameter sets; and
means for transmitting an uplink transmission with a transmission power based on the open loop power value in the one or more open loop power control parameter sets.

26. The apparatus of claim 25, wherein the indication comprises a set of bits in an open loop control parameter set indication field and wherein the one or more open loop power control parameter sets comprise two open loop power control parameter sets, wherein the set of bits includes at least one bit included in the indication that indicates one open loop power control parameter set of the two open loop power control parameter sets to use to determine the open loop power value and at least one set of one or more bits indicating the open loop power value within the one open loop power control parameter set indicated by the at least one bit.

27. The apparatus of claim 25, wherein the indication is included in downlink control information and comprises one of a first indication of a first open loop power control parameter set of the one or more open loop power control parameter sets indicating the open loop power value to use for the uplink transmission or a second indication of a duplex mode associated with the first open loop power control parameter set of the one or more open loop power control parameter sets indicating the open loop power value to use for the uplink transmission.

28. A computer-readable medium storing computer executable code at a wireless device, the code when executed by a processor causes the processor to:
receive a configuration of two or more open loop power values in one or more open loop power control parameter sets, each open loop power value of the two or more open loop power values associated with a different duplex mode;
receive an indication of an open loop power value of the two or more open loop power values in the one or more open loop power control parameter sets; and
transmit an uplink transmission with a transmission power based on the open loop power value in the one or more open loop power control parameter sets.

29. The computer-readable medium of claim 28, wherein the indication comprises a set of bits in an open loop control parameter set indication field and wherein the one or more open loop power control parameter sets comprise two open loop power control parameter sets, wherein the set of bits includes at least one bit included in the indication that indicates one open loop power control parameter set of the two open loop power control parameter sets to use to determine the open loop power value and at least one set of one or more bits indicating the open loop power value within the one open loop power control parameter set indicated by the at least one bit.

30. The computer-readable medium of claim 28, wherein the indication is included in downlink control information and comprises one of a first indication of a first open loop power control parameter set of the one or more open loop power control parameter sets indicating the open loop power value to use for the uplink transmission or a second indication of a duplex mode associated with the first open loop power control parameter set of the one or more open loop power control parameter sets indicating the open loop power value to use for the uplink transmission.
